(19) United States
(12) Patent Application Publication
(10) Pub. No.: US 2025/0008515 A1
(43) Pub. Date: Jan. 2, 2025

(54) PERFORMING SIMULTANEOUS WIRELESS COMMUNICATION OPERATIONS

(71) Applicant: Lenovo (Singapore) Pte. Ltd., New Tech Park (SG)

(72) Inventors: Majid Ghanbarinejad, Chicago, IL (US); Hyejung Jung, Northbrook, IL (US); Vijay Nangia, Woodridge, IL (US)

(21) Appl. No.: 18/263,876

(22) PCT Filed: Feb. 1, 2022
(86) PCT No.: PCT/IB2022/050837

§ 371 Date: Aug. 1, 2023

Related U.S. Application Data
(60) Provisional application No. 63/144,410, filed on Feb. 1, 2021.

(51) Int. Cl. H04W 72/20; H04W 72/0446; H04W 84/04

(52) U.S. Cl. CPC H04W 72/20; H04W 72/0446; H04W 84/047

(57) ABSTRACT

Apparatuses, methods, and systems are disclosed for performing simultaneous wireless communication operations. One method includes receiving, at a node, a first configuration of a first resource and a second configuration of a second resource. The first resource and the second resource overlap in a time domain. The method includes receiving first information associated with a first operation on the first resource and a second operation on the second resource. The method includes determining whether the node is capable of performing the first operation and the second operation simultaneously based at least in part on the first information. The method includes transmitting a control message including second information indicating whether the node is capable of performing the first operation and the second operation simultaneously.

### CROSS-REFERENCE TO RELATED APPLICATIONS

This application claims priority to U.S. Patent Application Ser. No. 63/144,410 entitled “APPARATUSES, METHODS, AND SYSTEMS FOR DYNAMIC SIGNALING ENHANCEMENTS IN INTEGRATED ACCESS AND BACKHAUL” and filed on Feb. 1, 2021 for Majid Ghanbarinejad, which is incorporated herein by reference in its entirety.

### FIELD

The subject matter disclosed herein relates generally to wireless communications and more particularly relates to performing simultaneous wireless communication operations.

### BACKGROUND

In certain wireless communications networks, integrated access and backhaul (“IAB”) systems may be used. In such networks, the IAB nodes in the IAB system may have multiple antenna panels operating with simultaneous transmissions and receptions.

### BRIEF SUMMARY

Methods for performing simultaneous wireless communication operations are disclosed. Apparatuses and systems also perform the functions of the methods. One embodiment of a method includes receiving, at a node, a first configuration of a first resource and a second configuration of a second resource. The first resource and the second resource overlap in a time domain. In some embodiments, the method includes receiving first information associated with a first operation on the first resource and a second operation on the second resource. In certain embodiments, the method includes determining whether the node is capable of performing the first operation and the second operation simultaneously based at least in part on the first information. In various embodiments, the method includes transmitting a control message including second information indicating whether the node is capable of performing the first operation and the second operation simultaneously.

One apparatus for performing simultaneous wireless communication operations includes a node. In some embodiments, the apparatus includes a receiver that: receives a first configuration of a first resource and a second configuration of a second resource, wherein the first resource and the second resource overlap in a time domain; and receives first information associated with a first operation on the first resource and a second operation on the second resource. In various embodiments, the apparatus includes a processor that determines whether the node is capable of performing the first operation and the second operation simultaneously based at least in part on the first information. In certain embodiments, the apparatus includes a transmitter that transmits a control message including second information indicating whether the node is capable of performing the first operation and the second operation simultaneously.

Another embodiment of a method for performing simultaneous wireless communication operations includes receiving, at a node, a configuration of a plurality of spatial parameters associated with the second entity. In some embodiments, the method includes receiving a control message from a serving node of the first entity. The control message indicates that at least one spatial parameter of the plurality of the spatial parameters is restricted. In certain embodiments, the method includes restricting a transmission by the second entity based on determining that the transmission is associated with the at least one spatial parameter.

Another apparatus for performing simultaneous wireless communication operations includes a node. In some embodiments, the apparatus includes a receiver that: receives a configuration of a plurality of spatial parameters associated with the second entity; and receives a control message from a serving node of the first entity. The control message indicates that at least one spatial parameter of the plurality of the spatial parameters is restricted. In various embodiments, the apparatus includes a processor that restricts a transmission by the second entity based on determining that the transmission is associated with the at least one spatial parameter.

### BRIEF DESCRIPTION OF THE DRAWINGS

A more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a wireless communication system for performing simultaneous wireless communication operations;

FIG. 2 is a schematic block diagram illustrating one embodiment of an apparatus that may be used for performing simultaneous wireless communication operations;

FIG. 3 is a schematic block diagram illustrating one embodiment of an apparatus that may be used for performing simultaneous wireless communication operations;

FIG. 4 is a schematic block diagram illustrating one embodiment of an IAB system in standalone mode;

FIG. 5 is a schematic block diagram illustrating another embodiment of a system;

FIG. 6 is a schematic block diagram illustrating one embodiment of an IAB system with single-panel and multi-panel IAB nodes;

FIG. 7 is a schematic block diagram illustrating one embodiment of types of simultaneous transmission and/or reception operations;

FIG. 8 is a schematic block diagram illustrating one embodiment of a system for an indication for upstream of an IAB node by a parent node compared to an indication for downstream of the IAB node;

FIG. 9 is a schematic block diagram illustrating one embodiment of a slot diagram showing a configuration of frequency-domain availability;

FIG. 10 is a schematic block diagram illustrating one embodiment of a system showing alternative scenarios for simultaneous operations;

FIG. 11 is a flow chart diagram illustrating one embodiment of a method for performing simultaneous wireless communication operations; and

FIG. 12 is a flow chart diagram illustrating another embodiment of a method for performing simultaneous wireless communication operations.

### DETAILED DESCRIPTION

As will be appreciated by one skilled in the art, aspects of the embodiments may be embodied as a system, apparatus, method, or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Certain of the functional units described in this specification may be labeled as modules, in order to more particularly emphasize their implementation independence. For example, a module may be implemented as a hardware circuit comprising custom very-large-scale integration (“VLSI”) circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, include one or more physical or logical blocks of executable code which may, for instance, be organized as an object, procedure, or function. Nevertheless, the executables of an identified module need not be physically located together, but may include disparate instructions stored in different locations which, when joined logically together, include the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (“RAM”), a read-only memory (“ROM”), an erasable programmable read-only memory (“EPROM” or Flash memory), a portable compact disc read-only memory (“CD-ROM”), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be any number of lines and may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (“LAN”) or a wide area network (“WAN”), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising.” “having.” and variations thereof mean “including but not limited to,” unless expressly specified otherwise. An enumerated listing of items does not imply that any or all of the items are mutually exclusive, unless expressly specified otherwise. The terms “a.” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. The code May be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which includes one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

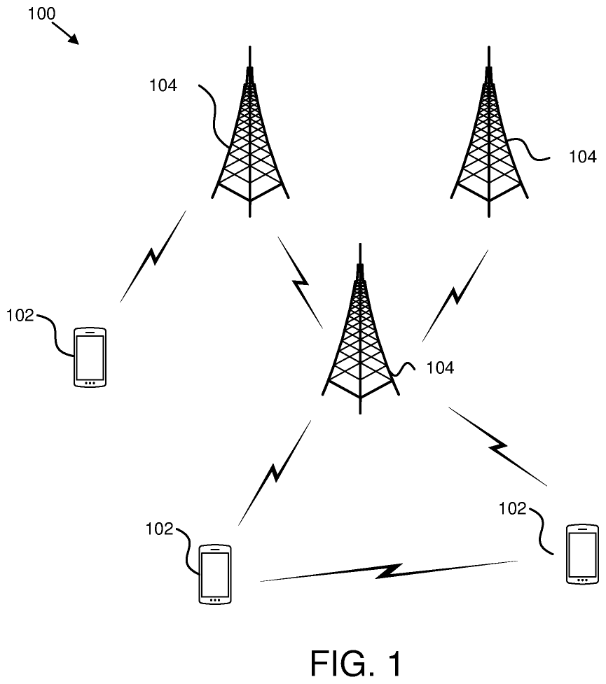

FIG. 1 depicts an embodiment of a wireless communication system 100 for performing simultaneous wireless communication operations. In one embodiment, the wireless communication system 100 includes remote units 102 and network units 104. Even though a specific number of remote units 102 and network units 104 are depicted in FIG. 1, one of skill in the art will recognize that any number of remote units 102 and network units 104 may be included in the wireless communication system 100.

In one embodiment, the remote units 102 may include computing devices, such as desktop computers, laptop computers, personal digital assistants (“PDAs”), tablet computers, smart phones, smart televisions (e.g., televisions connected to the Internet), set-top boxes, game consoles, security systems (including security cameras), vehicle on-board computers, network devices (e.g., routers, switches, modems), aerial vehicles, drones, or the like. In some embodiments, the remote units 102 include wearable devices, such as smart watches, fitness bands, optical head-mounted displays, or the like. Moreover, the remote units 102 may be referred to as subscriber units, mobiles, mobile stations, users, terminals, mobile terminals, fixed terminals, subscriber stations, UE, user terminals, a device, or by other terminology used in the art. The remote units 102 may communicate directly with one or more of the network units 104 via UL communication signals. In certain embodiments, the remote units 102 may communicate directly with other remote units 102 via sidelink communication.

The network units 104 may be distributed over a geographic region. In certain embodiments, a network unit 104 may also be referred to and/or may include one or more of an access point, an access terminal, a base, a base station, a location server, a core network (“CN”), a radio network entity, a Node-B, an evolved node-B (“eNB”), a 5G node-B (“gNB”), a Home Node-B, a relay node, a device, a core network, an aerial server, a radio access node, an access point (“AP”), new radio (“NR”), a network entity, an access and mobility management function (“AMF”), a unified data management (“UDM”), a unified data repository (“UDR”), a UDM/UDR, a policy control function (“PCF”), a radio access network (“RAN”), a network slice selection function (“NSSF”), an operations, administration, and management (“OAM”), a session management function (“SMF”), a user plane function (“UPF”), an application function, an authentication server function (“AUSF”), security anchor functionality (“SEAF”), trusted non-3GPP gateway function (“TNGF”), or by any other terminology used in the art. The network units 104 are generally part of a radio access network that includes one or more controllers communicably coupled to one or more corresponding network units 104. The radio access network is generally communicably coupled to one or more core networks, which may be coupled to other networks, like the Internet and public switched telephone networks, among other networks. These and other elements of radio access and core networks are not illustrated but are well known generally by those having ordinary skill in the art.

In one implementation, the wireless communication system 100 is compliant with NR protocols standardized in third generation partnership project (“3GPP”), wherein the network unit 104 transmits using an OFDM modulation scheme on the downlink (“DL”) and the remote units 102 transmit on the uplink (“UL”) using a single-carrier frequency division multiple access (“SC-FDMA”) scheme or an orthogonal frequency division multiplexing (“OFDM”) scheme. More generally, however, the wireless communication system 100 may implement some other open or proprietary communication protocol, for example, WiMAX, institute of electrical and electronics engineers (“IEEE”) 802.11 variants, global system for mobile communications (“GSM”), general packet radio service (“GPRS”), universal mobile telecommunications system (“UMTS”), long term evolution (“LTE”) variants, code division multiple access 2000 (“CDMA2000”), Bluetooth®, ZigBee, Sigfoxx, among other protocols. The present disclosure is not intended to be limited to the implementation of any particular wireless communication system architecture or protocol.

The network units 104 may serve a number of remote units 102 within a serving area, for example, a cell or a cell sector via a wireless communication link. The network units 104 transmit DL communication signals to serve the remote units 102 in the time, frequency, and/or spatial domain.

In various embodiments, a network unit 104 may receive, at a node, a first configuration of a first resource and a second configuration of a second resource. The first resource and the second resource overlap in a time domain. In some embodiments, the network unit 104 may receive first information associated with a first operation on the first resource and a second operation on the second resource. In certain embodiments, the network unit 104 may determine whether the node is capable of performing the first operation and the second operation simultaneously based at least in part on the first information. In various embodiments, the network unit 104 may transmit a control message including second information indicating whether the node is capable of performing the first operation and the second operation simultaneously. Accordingly, the network unit 104 may be used for performing simultaneous wireless communication operations.

In certain embodiments, a network unit 104 may receive, at a node, a configuration of a plurality of spatial parameters associated with the second entity. In some embodiments, the network unit 104 may receive a control message from a serving node of the first entity. The control message indicates that at least one spatial parameter of the plurality of the spatial parameters is restricted. In certain embodiments, the network unit 104 may restrict a transmission by the second entity based on determining that the transmission is associated with the at least one spatial parameter. Accordingly, the network unit 104 may be used for performing simultaneous wireless communication operations.

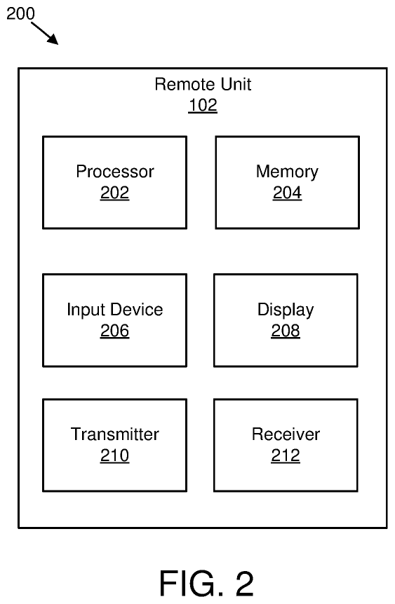

FIG. 2 depicts one embodiment of an apparatus 200 that may be used for performing simultaneous wireless communication operations. The apparatus 200 includes one embodiment of the remote unit 102. Furthermore, the remote unit 102 may include a processor 202, a memory 204, an input device 206, a display 208, a transmitter 210, and a receiver 212. In some embodiments, the input device 206 and the display 208 are combined into a single device, such as a touchscreen. In certain embodiments, the remote unit 102 may not include any input device 206 and/or display 208. In various embodiments, the remote unit 102 may include one or more of the processor 202, the memory 204, the transmitter 210, and the receiver 212, and may not include the input device 206 and/or the display 208.

The processor 202, in one embodiment, may include any known controller capable of executing computer-readable instructions and/or capable of performing logical operations. For example, the processor 202 may be a microcontroller, a microprocessor, a central processing unit (“CPU”), a graphics processing unit (“GPU”), an auxiliary processing unit, a field programmable gate array (“FPGA”), or similar programmable controller. In some embodiments, the processor 202 executes instructions stored in the memory 204 to perform the methods and routines described herein. The processor 202 is communicatively coupled to the memory 204, the input device 206, the display 208, the transmitter 210, and the receiver 212.

The memory 204, in one embodiment, is a computer readable storage medium. In some embodiments, the memory 204 includes volatile computer storage media. For example, the memory 204 may include a RAM, including dynamic RAM (“DRAM”), synchronous dynamic RAM (“SDRAM”), and/or static RAM (“SRAM”). In some embodiments, the memory 204 includes non-volatile computer storage media. For example, the memory 204 may include a hard disk drive, a flash memory, or any other suitable non-volatile computer storage device. In some embodiments, the memory 204 includes both volatile and non-volatile computer storage media. In some embodiments, the memory 204 also stores program code and related data, such as an operating system or other controller algorithms operating on the remote unit 102.

The input device 206, in one embodiment, may include any known computer input device including a touch panel, a button, a keyboard, a stylus, a microphone, or the like. In some embodiments, the input device 206 may be integrated with the display 208, for example, as a touchscreen or similar touch-sensitive display. In some embodiments, the input device 206 includes a touchscreen such that text may be input using a virtual keyboard displayed on the touchscreen and/or by handwriting on the touchscreen. In some embodiments, the input device 206 includes two or more different devices, such as a keyboard and a touch panel.

The display 208, in one embodiment, may include any known electronically controllable display or display device. The display 208 may be designed to output visual, audible, and/or haptic signals. In some embodiments, the display 208 includes an electronic display capable of outputting visual data to a user. For example, the display 208 may include, but is not limited to, a liquid crystal display (“LCD”), a light emitting diode (“LED”) display, an organic light emitting diode (“OLED”) display, a projector, or similar display device capable of outputting images, text, or the like to a user. As another, non-limiting, example, the display 208 may include a wearable display such as a smart watch, smart glasses, a heads-up display, or the like. Further, the display 208 may be a component of a smart phone, a personal digital assistant, a television, a table computer, a notebook (laptop) computer, a personal computer, a vehicle dashboard, or the like.

In certain embodiments, the display 208 includes one or more speakers for producing sound. For example, the display 208 may produce an audible alert or notification (e.g., a beep or chime). In some embodiments, the display 208 includes one or more haptic devices for producing vibrations, motion, or other haptic feedback. In some embodiments, all or portions of the display 208 may be integrated with the input device 206. For example, the input device 206 and display 208 may form a touchscreen or similar touch-sensitive display. In other embodiments, the display 208 may be located near the input device 206.

Although only one transmitter 210 and one receiver 212 are illustrated, the remote unit 102 may have any suitable number of transmitters 210 and receivers 212. The transmitter 210 and the receiver 212 may be any suitable type of transmitters and receivers. In one embodiment, the transmitter 210 and the receiver 212 may be part of a transceiver.

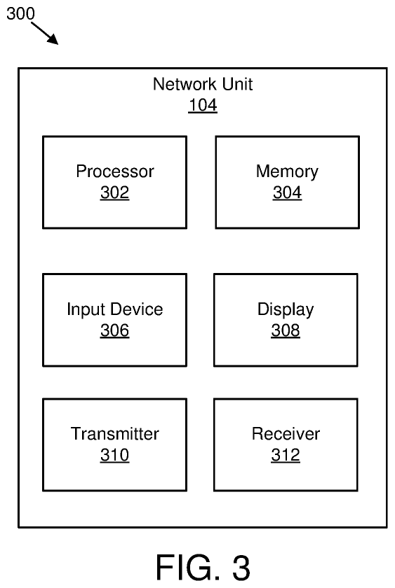

FIG. 3 depicts one embodiment of an apparatus 300 that may be used for performing simultaneous wireless communication operations. The apparatus 300 includes one embodiment of the network unit 104. Furthermore, the network unit 104 may include a processor 302, a memory 304, an input device 306, a display 308, a transmitter 310, and a receiver 312. As may be appreciated, the processor 302, the memory 304, the input device 306, the display 308, the transmitter 310, and the receiver 312 may be substantially similar to the processor 202, the memory 204, the input device 206, the display 208, the transmitter 210, and the receiver 212 of the remote unit 102, respectively.

In certain embodiments, the receiver 312: receives a first configuration of a first resource and a second configuration of a second resource, wherein the first resource and the second resource overlap in a time domain; and receives first information associated with a first operation on the first resource and a second operation on the second resource. In various embodiments, the processor 302 determines whether the node is capable of performing the first operation and the second operation simultaneously based at least in part on the first information. In certain embodiments, the transmitter 310 transmits a control message including second information indicating whether the node is capable of performing the first operation and the second operation simultaneously.

In some embodiments, the receiver 312: receives a configuration of a plurality of spatial parameters associated with the second entity; and receives a control message from a serving node of the first entity. The control message indicates that at least one spatial parameter of the plurality of the spatial parameters is restricted. In various embodiments, the processor 302 restricts a transmission by the second entity based on determining that the transmission is associated with the at least one spatial parameter.

In certain embodiments, integrated access and backhaul (“IAB”) may be used for new radio (“NR”). In such embodiments, IAB may facilitate increasing deployment flexibility and reducing fifth generation (“5G”) rollout costs. Moreover, IAB may enable service providers to reduce cell planning and spectrum planning efforts while using the wireless backhaul technology.

In some embodiments, a capability of an IAB node to perform enhanced resource multiplexing such as frequency division multiplexing (“FDM”) or spatial division multiplexing (“SDM”) may change depending on beam and/or panel usage information, transmit (“TX”) and/or receive (“RX”) powers, interference, or timing constraints. Furthermore, if an IAB node has multiple antenna panels, a certain panel or a certain beam on the panel may need to be restricted, released, or shared between upstream and downstream communications prior to a threshold so as to leave sufficient time for the IAB node to take action for simultaneous TX and/or RX.

In various embodiments, there may be enhancements to dynamic signaling among adjacent (e.g., parent and child) IAB nodes.

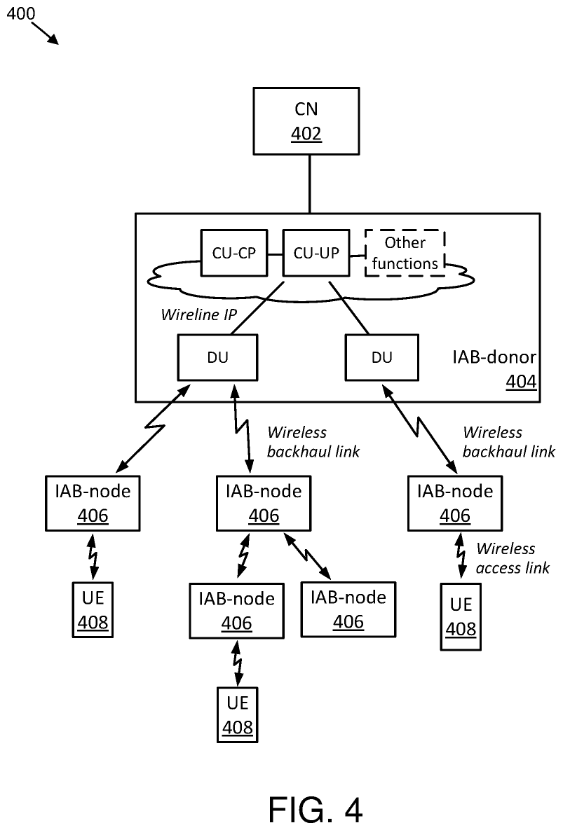

FIG. 4 is a schematic block diagram illustrating one embodiment of an IAB system 400 in standalone mode. The IAB system 400 includes a core network (“CN”) 402, an IAB-donor 404, IAB-nodes 406, and UEs 408. The CN 402 is connected to the IAB donor 404 of the IAB system 400 through a backhaul link, which is typically wired. The IAB donor 404 includes a central unit (“CU”) that communicates with all the distributed units (“DUs”) in the system through an F1* interface. The IAB donor 404 is a single logical node that may include a set of functions such as gNB-DU, gNB-CU-CP, gNB-CU-UP, and so forth. In certain deployments, the IAB donor 404 may be split according to these functions, which may all be either collocated or non-collocated. Moreover, each IAB node may be functionally split into at least a DU and a mobile terminal (“MT”). An MT of an IAB node may be connected to a DU of a parent node, which may be another IAB node or an IAB donor. A Uu link between an MT of an IAB node (called an IAB-MT) and a DU of a parent node (called an IAB-DU) is called a wireless backhaul link. In a wireless backhaul link, in terms of functionalities, the MT is similar to a UE and the DU of the parent node is similar to a base station in a conventional cellular wireless access link. Therefore, a link from an MT to a serving cell that is a DU of a parent link is called an uplink, and a link in the reverse direction is called a downlink. As used herein, embodiments may refer to an uplink or a downlink between IAB nodes, an upstream link or a downstream link of an IAB node, a link between a node and its parent node, a link between a node and its child node, and so forth without a direct reference to an IAB-MT, IAB-DU, serving cell, and so forth.

Each IAB donor or IAB node may serve UEs through access links. IAB systems may be designed to enable multi-hop communications (e.g., a UE may be connected to a core network through an access link and multiple backhaul links between IAB nodes and an IAB donor). As used herein, unless stated otherwise, an IAB node may refer to an IAB node or an IAB donor.

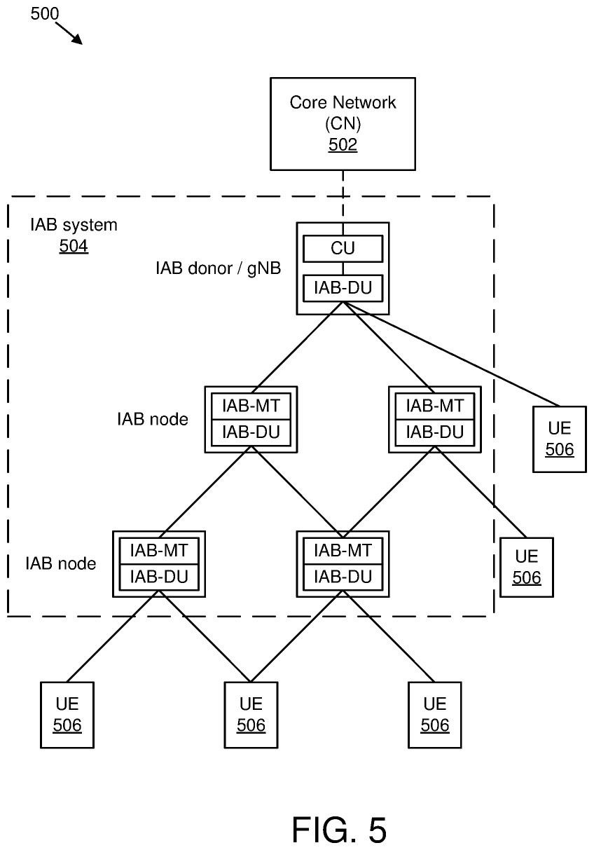

FIG. 5 is a schematic block diagram illustrating another embodiment of a system 500. Specifically, FIG. 5 illustrates functional splits of an IAB donor and IAB nodes. In this figure, an IAB node or a UE can be served by more than one serving cell as they support dual connectivity (“DC”). The system 500 includes a CN 502, an IAB system 504, and UEs 506. The CU and/or DU (“CU/DU”) split is in an IAB donor in the IAB system 504, and the DU/MT split is in IAB nodes in the IAB system 504.

It should be noted that a node and/or link closer to the IAB donor and/or CN 502 is called an upstream node and/or link. For example, a parent node of a subject node is an upstream node of the subject node and the link to the parent node is an upstream link with respect to the subject node. Similarly, a node and/or link farther from the IAB donor and/or core network is called a downstream node and/or link. For example, a child node of a subject node is a downstream node of the subject node and the link to the child node is a downstream link with respect to the subject node.

Table 1 summarize the terminology used herein for the sake of brevity versus a description that may appear in a specification.

TABLE 1

| Phrase | Description |
|---|---|
| Wireless | A connection between an MT of an IAB node and a |
| backhaul link | DU of a serving cell |
| Wireless | A connection between a UE and (a DU of) a serving |
| access link | cell |
| IAB-node/ | RAN node that supports NR access links to UEs and |
| IAB node | NR backhaul links to parent nodes and child nodes |
| IAB-MT | IAB-node function that terminates the Uu interface to |
| | the parent node |
| IAB-DU | gNB-DU functionality supported by the IAB-node to |
| | terminate the NR access interface to UEs and next- |
| | hop IAB-nodes, and to terminate the F1 protocol to |
| | the gNB-CU functionality on the IAB-donor |
| IAB-donor/ | gNB that provides network access to UEs via a |
| IAB donor | network of backhaul and access links |
| Parent [IAB] | An IAB node or IAB donor that comprises a serving |
| node | cell of the subject node. In some examples, IAB-MT's |
| | next hop neighbour node; the parent node may be an |
| | IAB-DU of an IAB-node or an IAB-donor. |
| Child [IAB] | An IAB node that identifies the subject node as a |
| node | serving cell. In some examples, IAB-DU's next hop |
| | neighbour node; the child node is also an IAB-node. |
| | In some embodiments, a UE or an enhanced UE or an |
| | IAB-enhanced UE may perform similarly to a child |
| | IAB node. |
| Sibling [IAB] | An IAB node that has a common parent with the |
| node | subject node |
| Uplink (of | A link from an MT to a DU of a parent node |
| a wireless | |
| backhaul link) | |
| Downlink (of | A link from a DU to an MT of a child node |
| a wireless | |
| backhaul link) | |
| Upstream | A node/link/etc. (topologically) closer to the IAB |
| node/link/etc. | donor/core network. Direction toward a parent node |
| | in an IAB topology. |
| Downstream | A node/link/etc. (topologically) farther from the IAB |
| node/link/etc. | donor/core network. Direction toward a child node or |
| | UE in an IAB topology. |

In certain embodiments, an “operation” or a “communication” may refer to a transmission or a reception in an uplink (or upstream) or a downlink (or downstream). Furthermore, the terms “simultaneous operation” or “simultaneous communications” may refer to multiplexing and/or duplexing transmissions and/or receptions by a node through one or more antennas and/or panels. Simultaneous operation, if not described explicitly, may be understood from the context.

Dynamic time division duplexing (“TDD”) may be used in NR through radio resource control (“RRC”) configurations and lower layer control signaling. Further, NR systems may facilitate more flexible slot formats for TDD operation that may be modified dynamically for adaptation to varying traffic. RRC may configure slots for TDD operation by the following information elements (“IEs”): 1) TDD-UL-DL-ConfigCommon: this IE determines a cell-specific uplink and/or downlink TDD configuration—the IE contains a periodicity value between 0.5 ms to 10 ms and a reference subcarrier spacing (“SCS”)—a slot configuration pattern (through one or two pattern fields) are then defined within the periodicity—the periodicity may contain multiple slots—the most general pattern for each periodicity is a number of downlink slots and symbols at the beginning and a number of uplink symbols and slots at the end-all the remaining slots and/or symbols in between are flexible and can be overridden by the following UE-specific configuration; and 2) TDD-UL-DL-ConfigDedicated: this IE determines a UE-specific uplink and/or downlink TDD configuration—the IE configures a number of slot configurations—each slots configuration contains an index based on the periodicity defined by the cell-specific configuration, and a number of downlink and uplink symbols in the slot, which can override flexible symbols configured by the cell-specific configuration.

Furthermore, resources that are still flexible (e.g., not configured downlink or uplink) by the cell-specific or UE-specific configuration may be dynamically indicated downlink or uplink by a DCI format 2_0 for a UE or a group of UEs. The DCI may contain slot format indicators (“SFIs”), each an index to a table of slot formats configured by the RRC. The configuration from the RRC refers to each slot format by an 8-bit number.

In some embodiments, 56 of 256 possible values (e.g., indexed 0-55) may be used to define slot formats of various combinations. The general format for each of the slot formats may be downlink (“DL”), flexible (“F”), uplink (“UL”) (“DL-F-UL”), where a slot format may contain one, two, or all the three types of the symbols with various numbers in the specified order. In various embodiments, 41 more values (e.g., indexed 56-96) may be used for UL-F-DL formats for IAB that provide further flexibility for an IAB node that may want to start a slot with uplink symbols followed by downlink symbols.

In various embodiments, resources that are not configured or indicated downlink or uplink by any of the above signaling may be assumed reserved, which may enable flexibility for cell management, coexistence, and so forth.

In certain embodiments, there may be resource configuration in NR IAB (e.g., Rel-16). It should be noted that more slot formats may be introduced in NR IAB (e.g., Rel-16) to facilitate higher flexibility.

Furthermore, in some embodiments, resources may be configured as hard (“H”), soft (“S”), or not available (“NA”). Hard resources may be assumed available for scheduling by an IAB node and NA resources may not be assumed available, while soft resources may be indicated available or not available dynamically. A dynamic availability indication (“AI”) for soft resources may be performed by DCI format 2_5 from a parent IAB node and/or donor, and may have similarities in formats and definitions with SFI (e.g., DCI format 2_0).

In various embodiments, resources may be shared between backhaul and access links, which may be configured semi-statically by a CU (e.g., IAB donor at layer-3) or dynamically by DU (e.g., parent IAB node at layer-1). Multiplexing between backhaul link and access link resources may be TDM, frequency division multiplexing (“FDM”), or may allow time-frequency resource sharing. Furthermore, resources may be allocated exactly (e.g., per node or per link) or in the form of a resource pool.

In certain embodiments, there may be time-domain allocation parameters. Specifically, time-domain allocation parameters k0, k1, k2 are used in various embodiments herein.

For physical downlink shared channel (“PDSCH”) time-domain allocation: the RRC parameter k0 in the RRC information element PDSCH-TimeDomainResourceAllocation indicates the offset between the slot that contains a downlink control information (“DCI”) that schedules a PDSCH and the slot that contains the PDSCH. The parameter k0 may not have an equivalent in LTE. Essentially, the offset is always 0 in LTE.

Moreover, for PDSCH hybrid automatic repeat request (“HARQ”) feedback timing: the layer 1 (“L1”) parameter k1 is provided by the ‘PDSCH-to-HARQ_feedback timing indicator’ field in the DCI formats 1_0 and 1_1 (e.g., for scheduling a PDSCH). The parameter 5 k1 may be equivalent to K in LTE TDD.

Furthermore, for physical uplink shared channel (“PUSCH”) time-domain allocation: the RRC parameter k2 in the RRC information element PUSCH-TimeDomainResourceAllocation indicates an offset between a slot that contains a DCI that schedules a PUSCH and the slot that contains the PUSCH. The parameter k2 may be equivalent 10 to the parameter k in LTE TDD.

The DCI formats may be as shown in Table 2.

TABLE 2

| DCI format | Usage |
|---|---|
| 0_0 | Scheduling of PUSCH in one cell |
| 0_1 | Scheduling of one or multiple PUSCH in one |
| | cell, or indicating downlink feedback |
| | information for configured grant PUSCH (CG- |
| | DFI) |
| 0_2 | Scheduling of PUSCH in one cell |
| 1_0 | Scheduling of PDSCH in one cell |
| 1_1 | Scheduling of PDSCH in one cell, and/or |
| | triggering one shot HARQ-ACK codebook |
| | feedback |
| 1_2 | Scheduling of PDSCH in one cell |
| 2_0 | Notifying a group of UEs of the slot format, |
| | available RB sets, COT duration and search |
| | space set group switching |
| 2_1 | Notifying a group of UEs of the PRB(s) and |
| | OFDM symbol(s) where UE may assume no |
| | transmission is intended for the UE |
| 2_2 | Transmission of TPC commands for PUCCH |
| | and PUSCH |
| 2_3 | Transmission of a group of TPC commands for |
| | SRS transmissions by one or more UEs |
| 2_4 | Notifying a group of UEs of the PRB(s) and |
| | OFDM symbol(s) where UE cancels the |
| | corresponding UL transmission from the UE |
| 2_5 | Notifying the availability of soft resources |
| 2_6 | Notifying the power saving information outside |
| | discontinuous reception (“DRX”) Active Time |
| | for one or more UEs |
| 3_0 | Scheduling of NR sidelink in one cell |
| 3_1 | Scheduling of LTE sidelink in one cell |

It should be noted that, as used herein, a DCI message scheduling a PUSCH may refer to a DCI format 0_0, 0_1, or 0_2; a DCI message scheduling a PDSCH may refer to a DCI format 1_0, 1_1, or 1_2; an SFI message may refer to a DCI format 2_0; and an AI message May refer to a DCI format 2_5.

Table 3 illustrates various timing alignment embodiments in IAB SI.

TABLE 3

| | | |
|---|---|---|
| Case | DL transmission timing alignment across | Supported for |
| #1 | IAB-nodes and IAB-donors | both access |
| | If DL TX and UL RX are not well aligned at | and backhaul |
| | the parent node, additional information about | link |
| | the alignment is needed for the child node to | transmission |
| | properly set its DL TX timing for OTA based | |
| | timing & synchronization | |
| Case | DL and UL transmission timing is aligned | Not |
| #2 | within an IAB-node | supported |
| Case | DL and UL reception timing is aligned within | Not |
| #3 | an IAB-node | supported |
| Case | within an IAB-node, when transmitting using | Not |
| #4 | Case #2 while when receiving using Case #3 | supported |
| Case | Case #1 for access link timing and Case #4 | Not |
| #5 | for backhaul link timing within an IAB-node | supported |
| | in different time slots | |
| Case | Case#1 DL transmission timing + Case #2 | If supported, |
| #6 | UL transmission timing | under control |
| | The DL transmission timing for all IAB- | of parent/ |
| | nodes is aligned with the parent IAB-node | network |
| | or donor DL timing | |
| | The UL transmission timing of an IAB-node | |
| | can be aligned with the IAB-node's DL | |
| | transmission timing | |
| Case | Case#1 DL transmission timing + Case #3 | Compatible |
| #7 | UL reception timing | with Rel-15 |
| | The DL transmission timing for all IAB- | UEs by |
| | nodes is aligned with the parent IAB-node | introducing |
| | or donor DL timing | an ″effective″ |
| | The UL reception timing of an IAB-node can | negative TA |
| | be aligned with the IAB-node's DL reception | |
| | timing | |
| | If DL TX and UL RX are not well aligned at | |
| | the parent node, additional information about | |
| | the alignment isn eeded for the child node to | |
| | properly set its DL TX timing for OTA | |
| | based timing & synchronization | |

In various embodiments, Case-1 is approved for IAB Rel-16, which focused on TDM, cases 2, 3, 4, and 5 may not be supported, and Case-6 and Case-7 may be candidates for enhanced timing alignment to facilitate and improve performance of FDM and/or SDM between simultaneous upstream and downstream operations.

In certain embodiments, an IAB system may be connected to a core network through one or more IAB donors. Further, each IAB node may be connected to an IAB donor and/or other IAB nodes through wireless backhaul links. Each IAB donor and/or node may also serve UEs.

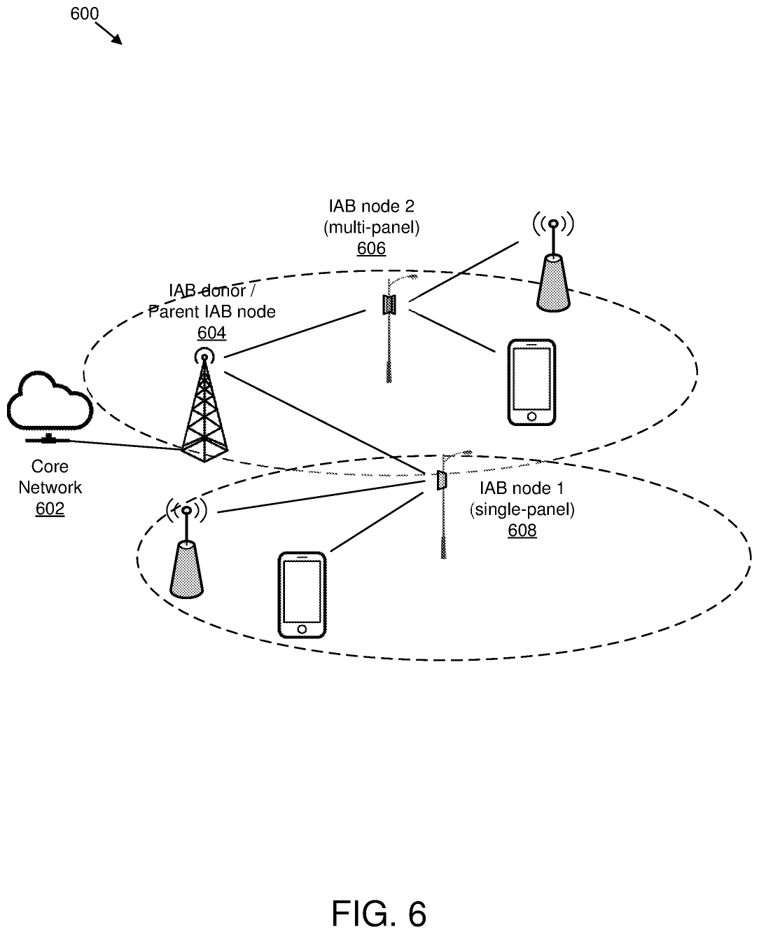

FIG. 6 is a schematic block diagram illustrating one embodiment of an IAB system 600 with single-panel and multi-panel IAB nodes. The IAB system 600 includes a core network 602, an IAB donor and/or parent IAB node 604, an IAB node 2 (e.g., multi-panel) 606, and an IAB node 1 (e.g., single-panel) 608.

There are various options with regards to the structure and multiplexing and/or duplexing capabilities of an IAB node. For example, each IAB node may have one or may antenna panels, each connected to the baseband unit through a radio frequency (“RF”) chain. The one or may antenna panels may be able to serve a wide spatial area of interest in a vicinity of the IAB node, or otherwise each antenna panel or each group of antenna panels may provide a partial coverage such as a “sector.” An IAB node with multiple antenna panels, each serving a separate spatial area or sector, may still be referred to as a single-panel IAB node as it behaves similarly to a single-panel IAB node for communications in each of the separate spatial areas or sectors.

In some embodiments, each antenna panel may be half-duplex (“HD”), meaning that it is able to either transmit or receive signals in a frequency band at a time, or full-duplex (“FD”), meaning that it is able to both transmit and receive signals in a frequency band simultaneously. Unlike full-duplex radio, half-duplex radio is widely implemented and used in practice and may be assumed to be a default mode of operation in wireless systems.

Table 4 lists different duplexing scenarios of interest if multiplexing is not constrained to time-division multiplexing (“TDM”). In table 4, single-panel and multi-panel IAB nodes are considered for different cases of simultaneous transmission and/or reception. Spatial-division multiplexing (“SDM”) may refer to either transmission or reception on downlink (or downstream) and uplink (or upstream) simultaneously; full duplex (“FD”) may refer to simultaneous transmission and reception by a same antenna panel in a frequency band; and multi-panel transmission and reception (“MPTR”) may refer to simultaneous transmission and/or reception by multiple antenna panels where each antenna panel either transmits or receives in a frequency band at a time.

TABLE 4

| | Architecture/ | Simultaneous | | | |
|---|---|---|---|---|---|
| Case# | Capability | TX/RX Type | IAB-MT | IAB-DU | Scenario# |
| Case A/ | Single-panel | TX SDM | UL-TX | DL-TX | S3 |
| Case#1 | Multi-panel | TX | UL-TX | DL-TX | S7 |
| | | MPTR/SDM | | | |
| Case B/ | Single-panel | RX SDM | DL-RX | UL-RX | S1 |
| Case#2 | Multi-panel | RX | DL-RX | UL-RX | S5 |
| | | MPTR/SDM | | | |
| Case C/ | Single-panel | UL FD | UL-TX | UL-RX | S4 |
| Case#3 | Multi-panel | UL | UL-TX | UL-RX | S8 |
| | | MPTR/FD | | | |
| Case D/ | Single-panel | DL FD | DL-RX | DL-TX | S2 |
| Case#4 | Multi-panel | DL | DL-RX | DL-TX | S6 |
| | | MPTR/FD | | | |

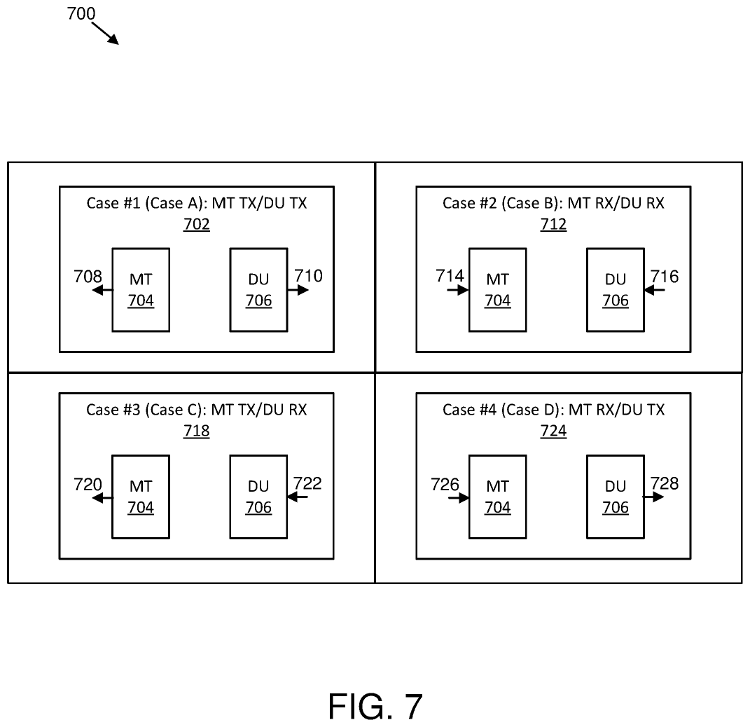

In table 4, based on a type of simultaneous operations and a number of panels in an IAB node, the scenarios are called S1, S2, . . . , S8, while the “Case” numbers (e.g., A/B/C/D or 1/2/3/4) may be in accordance with FIG. 7.

FIG. 7 is a schematic block diagram 700 illustrating one embodiment of types of simultaneous transmission and/or reception operations. The diagram 700 illustrates a first case 702 (e.g., Case #1, Case A, MT TX and DU TX) having an MT 704 and a DU 706, in which the MT 704 transmits 708 and the DU 706 transmits 710. Moreover, the diagram 700 illustrates a second case 712 (e.g., Case #2, Case B, MT RX and DU RX) having the MT 704 and the DU 706, in which the MT 704 receives 714 and the DU 706 receives 716. Further, the diagram 700 illustrates a third case 718 (e.g., Case #3, Case C, MT TX and DU RX) having the MT 704 and the DU 706, in which the MT 704 transmits 720 and the DU 706 receives 722. The diagram 700 illustrates a fourth case 724 (e.g., Case #4, Case D, MT RX and DU TX) having the MT 704 and the DU 706, in which the MT 704 receives 726 and the DU 706 transmits 728. As used herein, different cases may be referred to by the case #, case letter, or description as found in FIG. 7.

In certain embodiments, an IAB node transmits an indication and/or reporting message, such as a layer 1 (“L1”) and/or layer 2 (“L2”) control message, to a parent node. The indication and/or reporting message may include a parameter that indicates whether the IAB node is capable of performing simultaneous operations (e.g., according to an FDM and/or SDM scheme). Factors for determining whether it can perform simultaneous operations may include power imbalance, total power, interference, spatial constraints, and timing constraints associated with the simultaneous operations. The indication and/or reporting message may be associated with or may include information about: 1) certain time resources (e.g., one or more slots: certain symbols in one or more slots: all downlink (“DL”), uplink (“UL”), flexible (“F”), hard (“H”), soft (“S”), not available (“NA”), indicated available (“IA”), and/or indicated not available (“INA”) symbols in one or more slots: a time duration in ms, seconds, or frames: any of the above plus a guard time such as one or more guard symbols in a numerology): 2) certain frequency resources (e.g., one or more carriers or component carriers (“CCs”) or a fraction of a CC, one or more bandwidth parts (“BWPs”), a currently active BWP, or a fraction of a BWP: certain physical resource blocks (“PRBs”), groups of PRBs, resource block groups (“RBGs”), or groups of RBGs; all DL, UL, F. H, S, NA, IA, and/or INA resources in the frequency domain: a frequency band in Hz: any of the above plus a guard band in Hz or in PRBs in a numerology); and/or 3) certain spatial resources (e.g., one or more beams, transmission configuration indicator (“TCI”) states, or directions of communication: any of the above plus a guard space such as a difference in channel state information (“CSI”) reference signal (“RS”) (“CSI-RS”) resource indicator (“CRI”) values).

In some embodiments, an indication and/or reporting may be associated with resources in a time, frequency, and/or spatial domain. The resources may be associated with: 1) a value of TX power, TX power range, or TX power offset: 2) one or more beams, TCI states, or directions of communication: 3) a timing alignment mode (e.g., a TX alignment, an RX alignment), a timing alignment parameter (e.g., a TA parameter, a T_delta parameter), or a maximum tolerable timing misalignment parameter: 4) a signal or channel as configured by an IAB central unit (“CU”) (“IAB-CU”) or activated, triggered, and/or scheduled by a parent node—the determining whether the IAB node can perform FDM and/or SDM may be based on determining whether a priority associated with the signal or channel is higher than a priority associated with a simultaneous operation (e.g., transmission or reception)—for dual connectivity (“DC”) and/or multi-parent scenarios, the latter parent node may be different from the former parent node to which the IAB node transmits the indication/reporting: 5) an access link (e.g., between an IAB distributed unit (“DU”) (“IAB-DU”) and user equipment (“UE”)) or a backhaul link (e.g., between IAB-DU and child node or between IAB mobile transmitter (“MT”) (“IAB-MT”) and parent node): 6) any of the above in the time domain plus a guard time such as one or more guard symbols in a numerology: 7) any of the above in the frequency domain plus a guard band in Hz or in PRBs in a numerology; and/or 8) any of the above in the spatial domain plus a guard space such as a difference in CRI values.

In various embodiments, an indication and/or reporting may be unsolicited or in response to a control message, such as an L1/L2 control message, from a parent node. In the latter case, the resources associated with the indication and/or reporting message may be all or a subset of resources associated with the control message from the parent node. The control message may indicate a parameter related to power, beam and/or spatial information, timing alignment, a signal or channel, or the like. For DC and/or multi-parent scenarios, the latter parent node may be different from the former parent node to which the IAB node transmits the indication and/or reporting message.

In certain embodiments, an IAB node may transmit an indication and/or reporting message to a child node rather than a parent node.

In some embodiments, L1 and/or L2 control signaling may be used for transmitting an indication and/or reporting message. The indication and/or reporting message may be referred to as a simultaneous operation applicability (“SOA”) message. The SOA message may be an L1 and/or L2 control message such as an uplink control indication (“UCI”) message or a medium access control (“MAC”) message.

In various embodiments, an SOA message may include an indication of H resources, S resources, soft resources that are indicated available (“S-IA”), soft resources that are indicated not available (“S-INA”), or NA resources. In certain embodiments, an SOA message includes an indication of DL resources, UL resources, or F resources. In some embodiments, an SOA message may include an indication of H, S, S-IA, S-INA, and/or NA resources that are DL, UL, or F. Here, the indication may be in the time domain, in the frequency domain, in the spatial domain, or a combination thereof.

In certain embodiments, if a parent node receives an SOA message, it may take an action accordingly as described herein. A parameter in the SOA message that indicates whether the IAB node is capable of performing simultaneous operations may take at least a positive value ‘POS’ and a negative value ‘NEG’. This parameter may be a bit taking a value of ‘1’ or ‘0’, respectively. A positive value may indicate that the IAB node is capable of performing simultaneous operations, while a negative value may indicate that the IAB node is not capable of performing simultaneous operations.

In some embodiments, if an SOA message includes a ‘NEG’, a parent node does not schedule a TX and/or RX, cancels a TX and/or RX, does not activate a semi-persistent signal and/or channel, does not trigger an aperiodic signal and/or channel, or otherwise does not expect a TX and/or RX by the IAB node on a first resource, or on a second resource that is time-overlapping with a first resource. The first resource is indicated in, or associated with, the SOA message. In various embodiments, if the first resource or the second resource is a soft resource, a parent node does not indicate it available, indicates it not-available, or overrides it to be not-available.

In certain embodiments, if an SOA message includes a ‘NEG’, a parent node may determine whether an IAB node may have a TX and/or RX on a first resource, or on a second resource that is time-overlapping with a first resource. The first resource is indicated in, or associated with, the SOA message. If positive, the parent node does not schedule a TX and/or RX, cancels a TX and/or RX, does not activate a semi-persistent signal and/or channel, does not trigger an aperiodic signal and/or channel, or otherwise does not expect a TX and/or RX by the IAB node on the first resource or the second resource. In some embodiments, if the first resource or the second resource is a soft resource, a parent node does not indicate it available, indicates it not-available, or overrides it to be not-available.

In various embodiments, determining may be based on instantaneous information such as whether a first resource or a second resource is a hard resource or a soft resource that is indicated available to an IAB node. In certain embodiments, determining may be based on information received by a parent node indicating that a signal and/or channel is configured or scheduled on a first resource or a second resource.

In some embodiments, an IAB node may or may not be expected to take an action or status according to a standard.

In various embodiments, if an IAB node transmits an SOA message including a ‘NEG’, the IAB node is not expected to perform simultaneous operations on a first resource, or a second resource that is time-overlapping with a first resource. The first resource is indicated in, or associated with, the SOA message.

In certain embodiments, if an IAB node transmits an SOA message including a ‘NEG’, the IAB node is not expected to perform a TX and/or RX on a first resource, or a second resource that is time-overlapping with a first resource. The first resource is indicated in, or associated with, the SOA message. Moreover, the first resource or the second resource is either a H resource or a S resource that is indicated available (e.g., S-IA).

In some embodiments, an IAB node is not expected to perform simultaneous operations or a TX and/or RX only if a first resource or a second resource occurs later than a threshold. The threshold may be determined based on a time the SOA message is transmitted plus a decoding delay, a scheduling delay, and/or the like.

In various embodiments, upon transmitting or receiving an SOA message or upon determining that simultaneous operations is not applicable, a parent node and/or an IAB node may transmit a control message indicating a fallback to a TDM mode whereby the parent node and/or the IAB node may function according to IAB Rel-16. In certain embodiments, an operation status in a parent node and/or an IAB node may change to TDM-only. An IAB node transmitting or receiving a fallback message or switching to a TDM-only mode may produce and/or interpret signaling according to IAB Rel-16. The fallback or TDM-only mode may be applied to a certain time duration determined by a timer expiration or may otherwise continue until the IAB node is capable of performing simultaneous operations.

It should be noted that an IAB node may not expect to receive an availability indication (“AI”) message overriding an availability attribute (e.g., IA and/or INA) of a soft resource if the AI message is not received earlier than a threshold prior to an occurrence of the soft resource. The threshold may be at least equal to a decoding delay plus a scheduling delay such as a k0 or a k2 associated with the IAB node, a child node of the IAB node, or a UE served by the IAB node.

In certain embodiments, configuration messages from higher layers may provide an IAB node and its parent and/or child nodes with information for coordinated operation in IAB systems and may reduce signaling overhead.

In some embodiments, an IAB node may be configured with resources in time, frequency, and/or spatial domains. Each resource in any or all of these domains may be configured as H, S, or NA. Other resource types such as ‘shared’ are not precluded.

In various embodiments, a granularity for a resource configuration in a time domain may be a slot or a symbol. Moreover, a granularity for a resource configuration in a frequency domain may be a PRB, a group of PRBs, an RBG, a group of RBGs, a BWP, a fraction of a BWP, a fraction or all of a CC, or the like. Further, a granularity of a resource configuration in a frequency domain may be a panel, a beam, a direction of communication, or the like. In certain embodiments, not all such configurations may be available. For example, H, S, and/or NA configurations may be more practical in time-frequency domains while a panel and/or beam indication may be more practical in the spatial domain. In some embodiments, a method for a spatial domain may be employed jointly with an H, S, and/or NA framework in the spatial domain.

In certain embodiments, indicating a resource or a set of resources may be performed by indicating an identifier (“ID”) and/or index in a resource configuration. For example, a resource indication in time-frequency domains may be performed using a configuration ID, and/or an ID and/or an index to a resource configured by a configuration associated with the configuration ID. Similarly, a reference to a spatial-domain parameter, such as a TCI state, may be performed by indicating as associated TCI state ID. If an IAB node associates a TCI state with a panel of the IAB node or a beam on the panel, the TCI state ID may indirectly make a reference to a panel and/or beam. Various methods for using this indirect reference may be used.

In some embodiments, a spatial-domain indication may not be considered a resource domain similar to a time-frequency domain resource, but may be considered as an indication associated with time-frequency-domain resources or other parameters.

In various embodiments, power and timing parameters may be interpreted based on information from a higher layer configuration. Values of guard times, guard bands, guard space, and so forth may depend on a node capability and may be communicated among IAB nodes and IAB-CU via higher layer control signaling such as radio resource control (“RRC”) signaling.

In certain embodiments, each resource in any or all of time, frequency, and spatial domains may be configured with attributes such as DL, UL, and/or F. (e.g., ss specified for NR Rel-15 and/or 16). Each resource may be configured with additional attributes such as H, S, and/or NA. (e.g., as specified for IAB Rel-16). In some embodiments, assigning an H, S, and/or NA attribute to a resource is produced and interpreted based on a configuration of DL, UL, and/or F attributes. A similar approach may be taken for frequency and spatial domains.

In some embodiments, an IAB node receives a panel and/or beam indication message, such as an L1 and/or L2 control message from a parent node, including control information for an upstream or downstream of an IAB node.

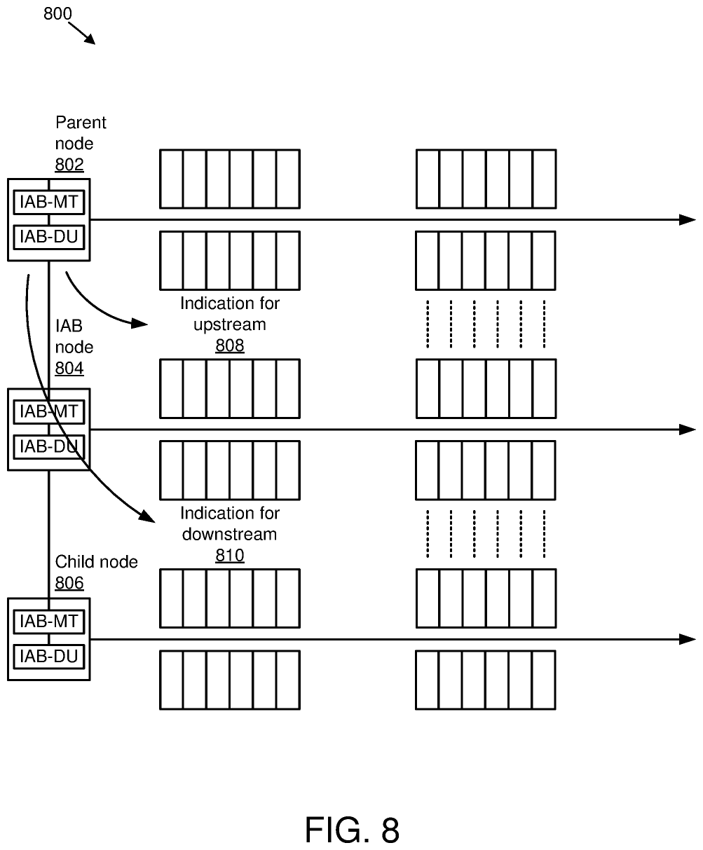

FIG. 8 is a schematic block diagram illustrating one embodiment of a system 800 for an indication for upstream of an IAB node by a parent node compared to an indication for downstream of the IAB node. The system 800 includes a parent node 802, an IAB node 804, and a child node 806 showing an indication for upstream 808 and an indication for downstream 810.

In various embodiments, an indication for upstream may include control information for communication between an IAB node and a parent node of the IAB node from which a behavior for downstream on time-overlapping resources (e.g., possibly plus guard times) may be inferred based on capability and operation constraints.

Moreover, in certain embodiments, an indication for downstream may include control information for communication between an IAB node and a child node of the IAB node (e.g., an availability indication per cell or per link) from which a behavior for upstream on the time-overlapping resources (e.g., possibly plus guard times) may be inferred based on capability and operation constraints.

In some embodiments, an indication and/or reporting message may include some or all of the following information: 1) upstream (e.g., between an IAB node and parent nodes, indication, triggering, and/or activation concepts): a) one or more panels and/or one or more beams on the panels of the IAB node to be used for, to be shared with, to be restricted to, to be released for, to be recommended for, or to be excluded for an upstream operation (e.g., an UL TX or a DL RX), and/or b) above panel and/or beam information associated with a set of time and/or frequency resources in an upstream link (e.g., per-link indication) or in any upstream link (e.g., for intra-carrier DC): 2) downstream (e.g., between the IAB node and child nodes or UEs, an availability indication concept): a) one or more panels and/or one or more beams on the panels of the IAB node to be used for, to be shared with, to be restricted to, to be released for, to be recommended for, or to be excluded for a downstream operation (e.g., a DL TX or a UL RX), and/or b) above panel and/or beam information associated with a set of time and/or frequency resources in a downstream link (e.g., per-link indication) or in any downstream link (e.g., per-cell indication).

In various embodiments, a panel and/or beam indication message may be interpreted or specified as an availability indication in the spatial domain.

In some embodiments, a behavior of an IAB node may be determined based on the following types of indication: 1) using a panel and/or beam: if a parent node indicates that a panel and/or beam of the IAB node is to be used for a first operation, the IAB node may assume that the panel and/or beam may be used for a second (e.g., simultaneous) operation provided that the second operation satisfies capability and operation constraints such as panel and/or beam, power, interference, and/or timing constraints—this type of indication may be mainly applicable to upstream while the second operation may be in downstream: 2) sharing a panel and/or beam: if a parent node indicates that a panel and/or beam of the IAB node is to be shared with a first operation, the IAB node may assume that the panel and/or beam may be used for a second (e.g., simultaneous) operation unconditionally—the IAB node may assume that any further signaling for the first operation will not limit the second operation (e.g., will only require a best-effort attempt based on panel and/or beam, power, interference, and/or timing constraints—this type of indication may be mainly applicable to upstream while the second operation may be in downstream: 3) restricting a panel and/or beam: if a parent node indicates that a panel and/or beam of the IAB node is to be restricted to a first operation, the IAB node may assume that the panel and/or beam may not be used for a second (e.g., simultaneous) operation-if a restriction is applied to upstream, the restriction may imply that a downstream on the indicated panel and/or beam is not available in downstream-conversely, if a restriction is applied to downstream, the restriction may imply that the indicated panel and/or beam is unconditionally available in the downstream: 4) releasing a panel and/or beam: if a parent node indicates that a panel and/or beam of the IAB node is to be released for a first operation, the IAB node may assume that the panel and/or beam may not be used for a second (e.g., simultaneous) operation any longer if the second operation does not satisfy capability and operation constraints such as panel and/or beam, power, interference, and/or timing constraints any longer—the indication message may include information associated with the capability and operation constraints that may change a condition based on which to determine whether to perform the first operation and the second operation on time-overlapping resources-if the indication is applied to upstream, the indication may determine availability of time-overlapping downstream resources-conversely, if the indication is applied to downstream, the indication may inform the IAB node that an upstream operation is not expected on time-overlapping upstream resources: 5) recommending a panel and/or beam: if a parent node indicates that a panel and/or beam of the IAB node is to be recommended for a first operation, the IAB node may infer that the panel and/or beam may be used for the first operation based on information for a second (e.g., simultaneous) operation that may or may not be fully available for the IAB node yet—this type of indication may be mainly applicable to downstream based on information of possible communication in a future upstream operation in terms of beam and/or panel, power, interference, or timing constraints—as a result, the IAB node may use time-overlapping downstream resources for communication with a child node or a UE while it does not have all the information it requires to evaluate capability or operation constraints for simultaneous operations; and/or 6) excluding a panel and/or beam: if a parent node indicates that a panel and/or beam of the IAB node is to be excluded for a first operation, the IAB node may infer that the panel and/or beam may not be used for the first operation-if the indication is applied to upstream, the IAB node may infer that the panel and/or beam is available for a second (e.g., simultaneous) operation-conversely, if the indication is applied to downstream, the indication may be understood as an availability indication in the spatial domain. If a first resource on a first link is time-overlapping with a second resource on a second link, then receiving an exclusion indication associated with the first resource may lead to a similar IAB node behavior as receiving a restriction indication associated with the second resource, or vice versa. However, since the parent node may only have partial information of resource and hardware configurations of the IAB node, it may use one type of indication rather than another.

In various embodiments, a panel, a beam on a panel, or a direction of communication may be indicated by a TCI state, a quasi-co-location (“QCL”) Type D indication, a QCL indication of another type, a panel ID, a port number, a beam ID such as a reference signal resource indicator, or the like. In such embodiments, multiple panels, multiple beams on one or more panels, or multiple directions of communication may be indicated by a set of TCI states, QCL indications, panel IDs, beam IDs, or the like.

In certain embodiments, an IAB node receives a panel and/or beam indication message including a set of spatial parameters. Each spatial parameter in the set may be associated with a panel and/or beam of the IAB node (e.g., an antenna panel), or a beam on an antenna panel of the IAB node. In such embodiments, in response, the IAB node may transmit a control message including a set of multiplexing capability indication parameters. Each parameter in the set may be associated with a panel and/or beam in the received panel and/or beam indication message. Each parameter may indicate whether the associated panel and/or beam is available for the associated indication. For example, each parameter may be interpreted as an acknowledgement (“ACK”) for the associated indication (e.g., a negative ACK in response to restricting a panel and/or beam may indicate to the parent node that the panel and/or beam may not be restricted, for example, due to a simultaneous TX and/or RX expected by the panel and/or beam, while a positive ACK confirms that the restriction request is accepted by the IAB node).

In some embodiments, for each parameter in a set, a positive indication value determines that an IAB node is capable of performing multiplexing between an upstream communication and a downstream communication while using an associated antenna panel and/or beam.

In various embodiments, a message, in response to a panel and/or beam indication message, may be an SOA message.

In certain embodiments, an IAB node may transmit an unsolicited response such as an unsolicited SOA message to a parent node informing the parent node about which panels and/or beams may be available for a simultaneous operation.

In some embodiments, an indication message may be transmitted by a child node, rather than a parent node, to the IAB node. Then, in such embodiments, similar methods may be applied for determining whether to perform simultaneous operations on resources that are time-overlapping with the resources associated with the indication message.

In various embodiments, the H, S, and/or NA framework, which may be used for time-domain signals in IAB Rel-16, may be extended to a spatial domain. However, due to fundamental differences between signal definitions in the time-frequency domain and the spatial domain, several modifications to a framework may be needed to obtain a practical solution for NR systems.

In certain embodiments, reference is made to a panel and/or beam of an IAB node. A panel and/or beam may mean an antenna panel of the IAB node, or a beam applied on an antenna panel of the IAB node. A beam may refer to a spatial filter in an analog domain and/or a digital domain. Moreover, a panel and/or beam may be realized by a spatial parameter such as a TCI state, a panel ID and/or a beam index, or the like. Therefore, a TCI state as a reference to a beam and/or panel may be an example and are not intended to limit scope.

In some embodiments, an IAB node may be configured with hard, soft, and NA resources in a spatial domain. A configuration may include a set of spatial parameters such as TCI states, wherein each TCI state may be configured as hard, soft, or NA.

In various embodiments, if a TCI state is configured as hard, an IAB-DU of the IAB node may use a panel and/or beam associated with the TCI state at any time. In certain embodiments, an IAB-DU may use a panel and/or beam if the using the panel and/or beam does not change a transmission or reception by the IAB-MU. Otherwise, if the TCI state is configured as soft, the IAB-DU may use the associated panel and/or beam if the using the panel and/or beam does not change a transmission or reception by the IAB-MU or if the TCI state is indicated available. Finally, if the TCI state is configured as NA, the IAB-DU may not use the associated panel and/or beam.

In certain embodiments, indicating availability of a soft TCI state by a parent node may have commonalities with soft resource availability indication in IAB Rel-16. In some embodiments, indicating availability of a soft TCI state by a parent node may be performed according to methods of panels and/or beam indications described herein. For example, if a soft TCI state is indicated to be restricted, the panel and/or beam associated with the TCI state is considered not available (e.g., INA or S-INA). Conversely, if a soft TCI is indicated to be excluded or shared, the panel and/or beam associated with the TCI state may be considered available (e.g., IA or S-IA).

In various embodiments, an IAB node may be configured with TCI states as in NR Rel-15 and/or 16. In such embodiments, a control message, such as a MAC message, may determine which TCI states are activated. The control message may use a bitmap similar to MAC control element (“CE”) logical channel identifier (“LCID”)=53 for determining which TCI states are activated. Then, a configuration or signaling may determine which of the activated TCI states are hard, soft, or NA. Then, a panel and/or beam associated with a hard TCI state may always be available, a panel and/or beam associated with an NA TCI state may always be unavailable, and a panel and/or beam associated with a soft TCI state may be available only when indicated available by a parent node.

In certain embodiments, an IAB node may be configured with TCI states as in NR Rel-15 and/or 16. Then, control signaling, such as MAC CE signaling, may determine which TCI states are hard, soft, or NA. For example, a first bitmap may determine which TCI states are hard and a second bitmap may determine which TCI states are soft. The first bitmap may include a sequence of bits, wherein a value of ‘1’ for a bit indicates that an associated TCI state is hard. Similarly, the second bitmap may include a sequence of bits, wherein a value of ‘1’ for a bit indicates that an associated TCI state is soft. In such embodiments, the two bitmaps may be in separate control messages wherein each control message has a format similar to MAC CE LCID=53. Alternatively, a sequence of values may determine whether a resource is hard, soft, neither, or NA. For example, if an attribute for each TCI state may take at most 4 values, 2 bits may be used for each TCI state. Then, if N TCI states are configured for the IAB node, a field of 2N bits are used in the control message that determines which TCI states are hard or soft. If a TCI state is not indicated as hard or soft, the IAB node may determine the TCI state as NA by default.

In some embodiments, other values may not be precluded. For example, four values for a TCI state may be used: hard, soft, shared, and/or NA. In such embodiments, an additional value such as ‘shared’ may be used if a panel and/or beam associated with a TCI state may be shared for TX and/or RX by an IAB-DU and an IAB-MT of the IAB node.

In various embodiments, a TCI state may be identified by a TCI state ID, or by an ID (e.g., possibly with smaller bit-width) based on which TCI states are indicated soft, shared, or any other types that may need an availability indication. This identification may be used in an SOA message, a response to an SOA message, an availability indication in the spatial domain, or other such control signaling. For example, if N TCI states are configured for an IAB node, from which M TCI states are indicated as soft by a configuration or signaling, then an index to the set of M TCI states may be used to indicate a soft TCI state. The index may need ┌log₂ M┐ bits or ┌log₂ Mₘₐₓ┐ bits, where Mₘₐₓ is the maximum number of TCI states that may be indicated as soft. For example, if a maximum of 8 TCI states may be indicated as soft, and an IAB node is configured with N TCI states from which 4 are currently soft, the IAB node may use ┌log₂ M┐=2 bits or ┌log₂ Mₘₐₓ┐=3 bits (according to different realizations) to refer to a TCI index for availability indication. As another example, any activate TCI state or any TCI state that is indicated hard or soft may be considered in the list of M TCI states. In this case, an availability indication for a hard TCI state may not be expected, may be ignored, or may be interpreted differently otherwise.

In certain embodiments, a TCI state, activated or not activated, may be used for soft resource indication and/or availability indication. That may provide more flexibility to the system as a panel and/or beam associated with an inactive TCI state may not be used for an IAB-MT (e.g., upstream) communication, but may still be indicated as available (e.g., IA) or not available (e.g., INA) to control interference by the IAB node, total TX power by the IAB node, or the like.

In some embodiments, additional frequency-domain features may be specified to determine whether frequency-domain resources such as PRBs are available or not available for each H, S, and/or NA symbol that is configured according to IAB in Rel-16. Furthermore, in such embodiments, any of the embodiments presented herein for the frequency domain may be extended to other signal domains such as the spatial domain, which may be employed individually or in combination with time-domain and frequency-domain counterparts.

In various embodiments, since availability of a resource on a time-frequency grid may now be determined by two values in two domains, tables shown herein may be used. The tables provide examples of how a hard, soft, or NA attribute may be inferred from a time-domain configuration (e.g., selecting a column from the table) and a frequency-domain configuration (e.g., selecting a row from the table). In each table, each column may represent a resource attribute in the time domain (e.g., from a configuration for a symbol or a slot), and each row may represent a resource attribute in the frequency domain (e.g., from a configuration for a PRB, a resource block group (RBG), a group of RBGs, a BWP, a fraction of a BWP, and so forth).

In certain embodiments, such as in Table 5, a resource is NA if it is indicated NA in either domain: a resource is S if it is indicated S in either domain; otherwise, a resource is H if it is indicated H in both domains.

TABLE 5

| | | | Not |
|---|---|---|---|
| | Hard | Soft | Available |
| Hard | Hard | Soft | Not |
| | | | Available |
| Soft | Soft | Soft | Not |
| | | | Available |
| Not | Not | Not | Not |
| Available | Available | Available | Available |

Another example is shown in Table 6. In this example, a resource is H or NA if it is indicated H or NA in the time domain, respectively; otherwise, if the resource is indicated S in the time domain, the resource obtains an H, S, or NA attribute the frequency domain.

TABLE 6

| | | | Not |
|---|---|---|---|
| | Hard | Soft | Available |
| Hard | Hard | Hard | Not |
| | | | Available |
| Soft | Hard | Soft | Not |
| | | | Available |
| Not | Hard | Not | Not |
| Available | | Available | Available |

Another example is shown in Table 7. In this example, a resource is NA if indicated NA in the frequency domain; otherwise, the resource takes a H, S, or NA attribute from the time domain.

TABLE 7

| | | | Not |
|---|---|---|---|
| | Hard | Soft | Available |
| Available or | Hard | Soft | Not |
| Hard or Soft | | | Available |
| Not | Not | Not | Not |
| Available | Available | Available | Available |

In some embodiments, any symbol, whether configured DL or UL or F, may be configured available or not available for a certain sub-band and/or set of PRBs in the BWP. Interpretation of a frequency-domain configuration and/or indication for H, S, and/or NA symbols according to Table 2 is as follows: 1) H symbol: if a symbol is configured as hard, any part of it in the frequency domain that is configured available is treated as a H resource in Rel-16 and any part of it that is configured not available is treated as a NA resource in Rel-16:2) S symbol: if a symbol is configured as soft, any part of it in the frequency domain that is configured available is treated as a S resource in Rel-16 and any part of it that is configured not available is treated as a NA resource in Rel-16-a soft resource may be subject to an availability indication similar to Rel-16-additionally, any soft resource may be further indicated available in the frequency domain; and/or 3) NA symbol: if a symbol is configured as not available, all frequency-domain resources will be treated as a NA resource in Rel-16. As an example behavior rule, further configuration of availability in the frequency domain does not change the symbol from NA.

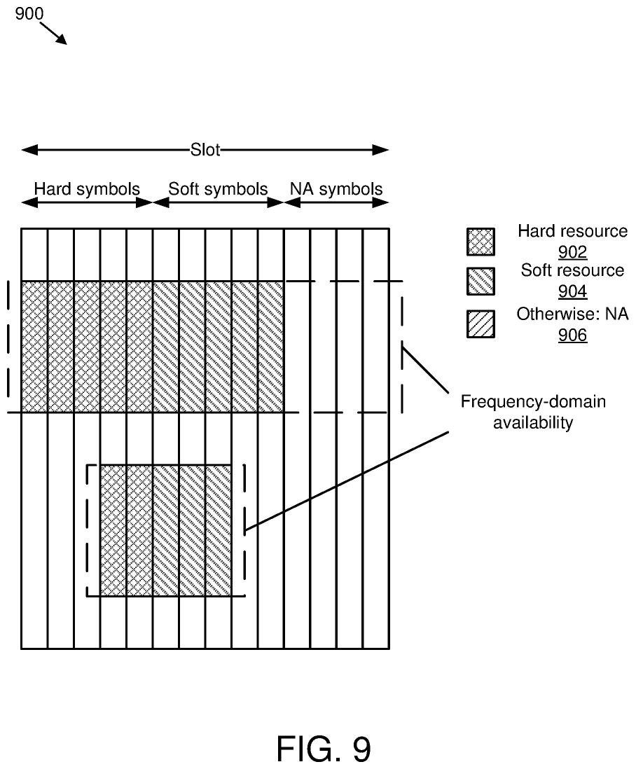

In various embodiments, a configuration of frequency-domain availability may be a mask on top of a time-domain resource configuration as in IAB Rel-16. An example is illustrated in FIG. 9.

FIG. 9 is a schematic block diagram illustrating one embodiment of a slot diagram 900 showing a configuration of frequency-domain availability for hard resources 902, soft resources 904, and NA 906.

Another example is shown in Table 8. In this example an H or NA symbol is H or NA on all its PRBs, while an S symbol may be S on some PRBs and NA on other PRBs depending on an attribute (e.g., such as H or S) in the frequency domain. In this case, soft PRBs on a soft symbol may be indicated available by an AI signaling from a parent IAB node.

TABLE 8

| | | | Not |
|---|---|---|---|
| | Hard | Soft | Available |
| Hard or | Hard | Soft | Not |
| Soft | | | Available |
| Not | Hard | Not | Not |
| Available | | Available | Available |

In certain embodiments, the following may be appliable to a resource in any or all of time, frequency, and spatial domains. Other signal domains are not precluded. Reference herein is made to time-frequency-spatial domain.

In some embodiments, if a downlink, uplink, or flexible resource in the time-frequency-spatial domain is configured as hard, the IAB-DU cell may respectively transmit, receive, or either transmit or receive in the resource.

In various embodiments, if a downlink, uplink, or flexible resource in the time-frequency-spatial domain is configured as soft, the IAB-DU can respectively transmit, receive or either transmit or receive in the resource only if: 1) the IAB-MT does not transmit or receive in the resource: 2) the IAB-MT would transmit or receive in the resource, and the transmission or reception in the symbol is not changed due to a use of the resource by the IAB-DU: or 3) the IAB-MT detects a DCI format 2_5 with an AI index field value indicating the soft resource as available.

In certain embodiments, if a resource in a time-frequency-spatial domain is configured as unavailable/NA, an IAB-DU neither transmits nor receives in the resource.

In some embodiments, a conditional availability indication may be applied for the use of soft resources. The soft resources may be in a time-frequency-spatial domain.

In various embodiments, configuration messages from higher layers may provide an IAB node and its parent and/or child nodes with information for coordinated operation in IAB systems and may reduce signaling overhead.

In certain embodiments, an IAB node may be configured with resources in time, frequency, and/or spatial domains. Each resource in any or all of those domains may be configured as H, soft, or NA. Other resource types such as ‘shared’ are not precluded.

In some embodiments, a granularity for a resource configuration in a time domain may be a slot or a symbol. Moreover, a granularity for a resource configuration in a frequency domain may be a PRB, a group of PRBs, an RBG, a group of RBGs, a BWP, a fraction of a BWP, a fraction or all of a CC, or the like. Further, a granularity of a resource configuration in a frequency domain may be a panel, a beam, a direction of communication, or the like. In various embodiments, not all such configurations may be available. For example, H, S, and/or NA configurations may be more practical in time-frequency domains while a panel and/or beam indication method may be more practical in the spatial domain. In certain embodiments, a method for the spatial domain may be employed jointly with an H, S, and/or NA framework in the spatial domain.

In various embodiments, as a result, indicating a resource or a set of resources may be performed by indicating an ID and/or index in a resource configuration. For example, a resource indication in time-frequency domains may be performed by using a configuration ID and/or an ID and/or index to a resource configured by the configuration associated with the configuration ID. Similarly, a reference to a spatial-domain parameter, such as a TCI state, may be performed by indicating an associated TCI state ID. If an IAB node associates a TCI state to a panel of the IAB node or a beam on the panel, the TCI state ID may indirectly make a reference to the panel and/or beam.

In certain embodiments, a spatial-domain indication may not be considered a resource domain similar to a time-frequency domain resource, but rather considered as an indication associated with a time-frequency-domain resources or other parameters. Each resource in any or all of time, frequency, and spatial domains may be configured with attributes such as DL, UL, and/or F (e.g., as specified for NR Rel-15 and/or 16). Each resource may be configured with additional attributes such as H, S, and/or NA (e.g., as specified for IAB Rel-16). In the latter case, assigning an H, S, and/or NA attribute to a resource is produced and interpreted based on a configuration of DL, UL, and/or F attributes. A similar approach may be taken for frequency and spatial domains.

In some embodiments, there may be an emphasis on simultaneous operations among upstream and downstream links. However, the embodiments are not limited in scope to simultaneous operations among upstream and downstream links. One example may include simultaneous operations among downstream links, where each link may be between the IAB node and a child node (e.g., backhaul link) or between the IAB node and a UE (e.g., access link) sharing resources in at least one of time, frequency, and spatial domains. Another example may include dual-connectivity (“DC”) or multi-parent scenarios, where each parent node is on a separate upstream link sharing resources in time, frequency, and/or spatial domains.

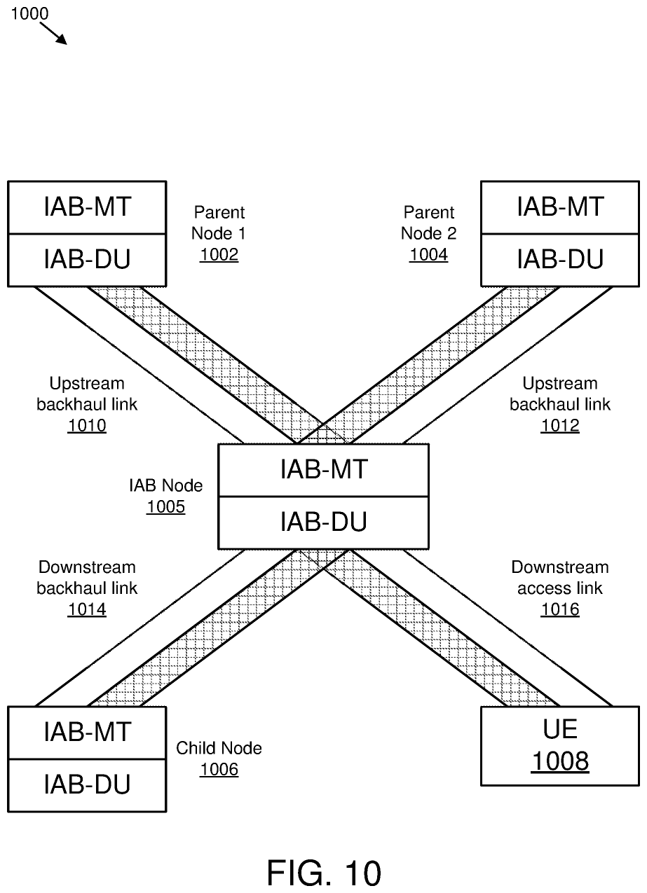

FIG. 10 is a schematic block diagram illustrating one embodiment of a system 1000 showing alternative scenarios for simultaneous operations. The system 1000 includes a parent node 1 1002, a parent node 2 1004, an IAB node 1005, a child node 1006, and a UE 1008 that use upstream backhaul links 1010 and 1012, and downstream backhaul links 1014 and 1016. In FIG. 10, each of the backhaul and access links in upstream and downstream of the IAB node may have resources (e.g., not filled) that are not overlapping with resources used in other links. However, some resources (e.g., shaded) on one link may be overlapping with resources on one or multiple other links in time, frequency, and/or spatial domains. Particularly, if resources are overlapping in the time domain, methods for simultaneous operations may be applied.

In various embodiments, signaling mechanisms in NR allow DL and/or UL to communicate information of an OFDM symbol to a UE using: 1) semi-static RRC signaling: 2) dynamic slot format indication (“SFI”) shared by a group of UEs; and/or 3) dynamic signaling to schedule a channel for a UE.

In certain embodiments, configurations or signaling for an IAB-MT or an IAB-DU may be used.

In some embodiments, for an IAB-MT, a configuration or signaling may be received by an IAB node from an IAB-CU or a parent node serving the IAB node. For example, if the description reads “an IAB-MT is configured by a resource configuration,” it may mean that the IAB node including the IAB-MT has received the resource configuration for the IAB-MT.

In various embodiments, for an IAB-DU, the configuration or signaling may be received by an IAB node from an IAB-CU or a parent node serving the IAB node. In certain embodiments, a configuration or signaling may be received by a child node served by the IAB-DU, in which case the IAB-DU may also inform the configuration or signaling to the child node. For example, if the description reads “an IAB-DU is configured by a resource e configuration,” it may mean a child node (or a UE or an enhanced UE) served by the IAB-DU has received the resource configuration, in which case the IAB node including the IAB-DU may also be informed of the resource configuration.

In certain embodiments, a configuration or signaling may be received from an IAB-CU on an F1 interface. In some embodiments, a control signaling may be received from a parent node or a child node on a physical control channel or by a MAC message.

In some embodiments, SDM may refer to a scenario where same frequency resources are used for multiple operations that are multiplexed in the spatial domain (e.g., by multiple antenna panels and/or multiple beams). In various embodiments, FDM may refer to a scenario where different frequency resources are used for multiple operations that may or may not be multiplexed in a spatial domain. Such embodiments may reuse time resources, although TDM is not precluded, possibly in combination of SDM and/or FDM. As such, a combination of SDM and FDM and possible combination with other multiplexing schemes such as code division multiplexing (“CDM”) is not precluded.

In certain embodiments, SDM may refer to multi-panel operation where multiple antennas, antenna panels, antenna ports, and so forth may be used for multiplexing communications.

In some embodiments, resource configurations may include TDD-UL-DL-ConfigCommon and TDD-UL-DL-ConfigDedicated as well as TDD-UL-DL-ConfigDedicated-IAB-MT-r16. Furthermore, RRC IEs may be used, which may be called TDD-UL-DL-ConfigDedicated2-r17 or TDD-UL-DL-ConfigDedicated2-IAB-MT-r17, for example.

In various embodiments, reference is made to time-overlapping (“TOL”) resources such as TOL symbols, although the standard specification may use a different term for overlapping resources or simply refer to “same” resources. Moreover, TOL resources may be defined or configured for different entities, such as different IAB nodes, an IAB-MT and IAB-DU of an IAB node, and so forth. In certain embodiments, there may be cases with different numerologies where a symbol in a first operation and/or configuration may not have the same length in time as a symbol in a second operation and/or configuration. In some embodiments, there may be cases having a timing misalignment, whether deliberate due to employing different timing alignments or due to an error.

In certain embodiments, TOL, as a relationship between two resources, is commutative (e.g., if a first resource and/or symbol A is time-overlapping with a second resource and/or symbol B, then B is also TOL with A). In some embodiments, there may be a symbol in a first operation and/or configuration and a TOL symbol in a second operation and/or configuration.

In various embodiments, an “operation” may refer to a transmission (“TX”) of a signal or a reception (“RX”) of signal. In this context, a simultaneous operation may refer to simultaneous transmissions, simultaneous receptions, or simultaneous transmissions and receptions by two communication entities. In certain embodiments, two entities may belong to a same node such as an IAB node. In some embodiments, two entities may be an IAB-MT and an IAB-DU of an IAB node.

While embodiments herein may be described for symbols, such as OFDM symbols, as a unit of time resources, the embodiments can be extended to other units such as slots, mini-slots, subframes, a group of symbols such as all the DL, UL, or F symbols in a slot or a group of slots, and so forth. Furthermore, the embodiments may be extended to the frequency domain (e.g., with a unit of resource element, resource block, sub-channel, and so forth) or other domains.

In certain embodiments, such as for Case A duplexing, which is simultaneous IAB-MT TX (e.g., UL) and IAB-DU TX (e.g., DL), the following may be applicable: 1) simultaneous TX capability: this may refer to an IAB node's capability to perform simultaneous transmissions, which may indicate that the IAB node is capable of SDM and/or FDM, the IAB node has multiple antenna panels (e.g., SDM), the IAB node is capable of simultaneous transmissions in DL and UL, the IAB node is capable of enhanced duplexing, or the like—in the case of configuration-based methods, information of the capability may be sent to an IAB-CU that configures the system—in the case of methods based on control signaling, the information of the capability may be sent to another IAB node such as a parent node or a child node: 2) power imbalance constraint: this may refer to a constraint according to which the difference between a TX powers for an IAB-MT TX and an IAB-DU TX is not larger than a threshold—the threshold may be determined by an IAB node capability that specifies a maximum power imbalance on one panel (e.g., FDM) or among multiple panels (e.g., SDM)—in the case of configuration-based methods, a power imbalance constraint may be satisfied by semi-static configuration of TX powers—in the case of methods based on control signaling, a TX power for an IAB-MT TX may be determined by a parent node serving the IAB-MT, therefore, a power imbalance constraint may require an IAB node to adjust a TX power for an IAB-DU TX, if possible, or decline a transmission otherwise: 3) total power constraint: this may refer to a constraint according to which the total TX power for an IAB-MT TX and an IAB-DU TX does not exceed a threshold—the threshold may be determined by an IAB node capability that specifies a maximum total power for a panel (e.g., FDM) or for the IAB node (e.g., SDM), by a regulatory limit, or the like—in the case of configuration-based methods, a total power constraint may be satisfied by semi-static configuration of TX powers—in the case of methods based on control signaling, a TX power for an IAB-MT TX may be determined by a parent node serving the IAB-MT, therefore, a total power constraint may require an IAB node to adjust a TX power for an IAB-DU TX, if possible, or decline a transmission otherwise: 4) interference constraint: this may refer to a variety of interference constraints between antennas of an IAB node (self-interference), interference on other nodes or channels or cells, and so forth—in some embodiments, according to an interference constraint, the interference by an IAB-DU TX on a parent node should be below a threshold when the parent node performs beamforming for receiving a signal from the IAB-MT—in various embodiments, according to an interference constraint, the interference by the IAB-MT TX on a child node should be below a threshold when the child node performs beamforming for receiving a signal from the IAB-DU: 5) guard band constraint: this may refer to a constraint according to which the frequency resources (e.g., PRBs) allocated to the IAB-MT is separated from the frequency resources allocated to the IAB-DU by at least a threshold called a guard band-a value of the guard band may be determined by an IAB node capability for one panel (e.g., FDM) or among multiple panels (e.g., SDM)—in the case of configuration-based methods, a resource may be allocated by a configuration—in the case of methods based on control signaling, a resource may be allocated by control message such as an L1/L2 message: 6) spatial constraint (e.g., FDM): this may refer to a constraint according to which a beam (e.g., spatial filter) for transmitting a signal is constrained by a beam (e.g., spatial filter) for transmitting another signal-a common case for this constraint is when one or multiple antenna panels are controlled by a same circuitry for controlling beamforming—in this case, if the one or multiple panels are beamformed to transmit a first signal in a particular direction in the spatial domain, any second signal may be constrained to be transmitted with a same beamforming configuration if the same one or multiple panels is to be used-whether a spatial constraint applies to an IAB node or an antenna panel of an IAB node may be determined by a capability of the IAB node, which may be communicated to an IAB-CU (e.g., in the case of configuration-based methods) or another IAB node such as a parent node or a child node (e.g., in the case of methods based on control signaling); and/or 7) timing alignment constraint (e.g., FDM): this constraint may be applicable if the antenna panel is connected to a baseband processor with one discrete Fourier transform (“DFT”) and/or inverse DFT (“IDFT”) window—in this case, the timing for an IAB-MT TX and an IAB-DU TX should be aligned at least at a symbol level—the timing alignment may correspond to a Case-6 timing scheme as specified by the standard, configured by the network, signaled by a parent node, and so forth.

In some embodiments, for Case B duplexing, which is simultaneous IAB-MT RX (e.g., DL) and IAB-DU RX (e.g., UL), the following may be applicable: 1) simultaneous RX capability: this may refer to an IAB node's capability to perform simultaneous receptions, which may indicate that the IAB node is capable of SDM and/or FDM, the IAB node has multiple antenna panels (e.g., SDM), the IAB node is capable of simultaneous receptions in DL and UL, the IAB node is capable of enhanced duplexing, or the like—in the case of configuration-based methods, information of the capability may be sent to an IAB-CU that configures the system—in the case of methods based on control signaling, the information of the capability may be sent to another IAB node such as a parent node or a child node: 2) power imbalance constraint: this may refer to a constraint according to which the difference between RX powers for an IAB-MT RX and an IAB-DU RX is not larger than a threshold—the threshold may be determined by an IAB node capability that specifies a maximum power imbalance on one panel (e.g., FDM) or among multiple panels (e.g., SDM)—in the case of configuration-based methods, a power imbalance constraint may be satisfied by semi-static configuration of TX powers—in the case of methods based on control signaling, a TX power for a child node TX may be determined by an IAB-DU serving the child node, therefore, a power imbalance constraint may require a parent node to adjust a TX power for a parent node TX, if possible, or decline a transmission otherwise-alternatively, an IAB-DU may need to signal a child node to adjust its TX power in order to satisfy a power imbalance constraint while the RX power from a parent node serving an IAB-MT is determined or known by the IAB node: 3) interference constraint: this may refer to a variety of interference constraints between antennas of an IAB node (e.g., self-interference), interference on other nodes or channels or cells, and so forth—in certain embodiments, according to an interference constraint, the interference by a child node on an IAB-MT RX should be below a threshold when the IAB-MT performs beamforming for receiving a signal from a parent node—in some embodiments, according to an interference constraint, the interference by a parent node on an IAB-DU RX should be below a threshold when the IAB-DU performs beamforming for receiving a signal from a child node: 4) guard band constraint: this may refer to a constraint according to which the frequency resources (e.g., PRBs) allocated to the IAB-MT is separated from the frequency resources allocated to the IAB-DU by at least a threshold called a guard band-a value of the guard band may be determined by an IAB node capability for one panel (e.g., FDM) or among multiple panels (e.g., SDM)—in the case of configuration-based methods, a resource may be allocated by a configuration—in the case of methods based on control signaling, a resource may be allocated by control message such as an L1 and/or L2 message: 5) spatial constraint (e.g., FDM): this may refer to a constraint according to which a beam (e.g., spatial filter) for receiving a signal is constrained by a beam (e.g., spatial filter) for receiving another signal-a common case for this constraint is when one or multiple antenna panels are controlled by a same circuitry for controlling beamforming—in this case, if the one or multiple panels are beamformed to receive a first signal in a particular direction in the spatial domain, any second signal may be constrained to be received with a same beamforming configuration if the same one or multiple panels is to be used-whether a spatial constraint applies to an IAB node or an antenna panel of an IAB node may be determined by a capability of the IAB node, which may be communicated to an IAB-CU (e.g., in the case of configuration-based methods) or another IAB node such as a parent node or a child node (e.g., in the case of methods based on control signaling); and/or 6) timing alignment constraint (e.g., FDM): this constraint may be applicable if the antenna panel is connected to a baseband processor with one DFT and/or IDFT window—in this case, the timing for an IAB-MT RX and an IAB-DU RX should be aligned at least at a symbol level—the timing alignment may correspond to a Case-7 timing scheme as specified by the standard, configured by the network, signaled by a parent node, and so forth.

In various embodiments, for Case C duplexing, which is simultaneous IAB-MT TX (e.g., UL) and IAB-DU RX (e.g., UL), and Case D duplexing, which is simultaneous IAB-MT RX (e.g., DL) and IAB-DU TX (e.g., DL), the following may be applicable: 1) simultaneous TX and/or RX capability: this may refer to an IAB node's capability to perform simultaneous transmission and reception, which may indicate that the IAB node is capable of SDM and/or FDM, the IAB node has multiple antenna panels (e.g. SDM), the IAB node is capable of simultaneous transmission and reception in DL and UL, the IAB node is capable of enhanced duplexing, or the like—in the case of configuration-based methods, information of the capability may be sent to an IAB-CU that configures the system—in the case of methods based on control signaling, the information of the capability may be sent to another IAB node such as a parent node or a child node: 2) interference constraint: this may refer to a variety of interference constraints between antennas of an IAB node (e.g., self-interference), interference on other nodes or channels or cells, and so on—in certain embodiments, according to an interference constraint, the interference by a child node on a parent node RX should be below a threshold when the parent node performs beamforming for receiving a signal from an IAB-MT—for Case C, according to an interference constraint, the interference by an IAB-MT on an IAB-DU RX should be below a threshold when the IAB-DU performs beamforming for receiving a signal from a child node—for Case D, according to an interference constraint, the interference by an IAB-DU on an IAB-MT RX should be below a threshold when the IAB-MT performs beamforming for receiving a signal from a parent node; and/or 3) guard band constraint: this may refer to a constraint according to which the frequency resources (e.g., PRBs) allocated to the IAB-MT is separated from the frequency resources allocated to the IAB-DU by at least a threshold called a guard band-a value of the guard band may be determined by an IAB node capability for one panel (e.g., FDM) or among multiple panels (e.g., SDM)—in the case of configuration-based methods, a resource may be allocated by a configuration—in the case of methods based on control signaling, a resource may be allocated by control message such as an L1 and/or L2 message.

In some embodiments, the terms antenna, panel, and antenna panel are used interchangeably. An antenna panel may be hardware that is used for transmitting and/or receiving radio signals at frequencies lower than 6 GHz (e.g., frequency range 1 (“FR1”)), or higher than 6 GHz (e.g., frequency range 2 (“FR2”) or millimeter wave (“mmWave”)). In certain embodiments, an antenna panel may include an array of antenna elements. Each antenna element may be connected to hardware, such as a phase shifter, that enables a control module to apply spatial parameters for transmission and/or reception of signals. The resulting radiation pattern may be called a beam, which may or may not be unimodal and may allow the device to amplify signals that are transmitted or received from spatial directions.

In various embodiments, an antenna panel may or may not be virtualized as an antenna port. An antenna panel may be connected to a baseband processing module through a radio frequency (“RF”) chain for each transmission (e.g., egress) and reception (e.g., ingress) direction. A capability of a device in terms of a number of antenna panels, their duplexing capabilities, their beamforming capabilities, and so forth, may or may not be transparent to other devices. In some embodiments, capability information may be communicated via signaling or capability information may be provided to devices without a need for signaling. If information is available to other devices the information may be used for signaling or local decision making.

In some embodiments, a UE antenna panel may be a physical or logical antenna array including a set of antenna elements or antenna ports that share a common or a significant portion of a radio frequency (“RF”) chain (e.g., in-phase and/or quadrature (“I/Q”) modulator, analog to digital (“A/D”) converter, local oscillator, phase shift network). The UE antenna panel or UE panel may be a logical entity with physical UE antennas mapped to the logical entity. The mapping of physical UE antennas to the logical entity may be up to UE implementation. Communicating (e.g., receiving or transmitting) on at least a subset of antenna elements or antenna ports active for radiating energy (e.g., active elements) of an antenna panel may require biasing or powering on of an RF chain which results in current drain or power consumption in a UE associated with the antenna panel (e.g., including power amplifier and/or low noise amplifier (“LNA”) power consumption associated with the antenna elements or antenna ports). The phrase “active for radiating energy,” as used herein, is not meant to be limited to a transmit function but also encompasses a receive function. Accordingly, an antenna element that is active for radiating energy may be coupled to a transmitter to transmit radio frequency energy or to a receiver to receive radio frequency energy, either simultaneously or sequentially, or may be coupled to a transceiver in general, for performing its intended functionality. Communicating on the active elements of an antenna panel enables generation of radiation patterns or beams.

In certain embodiments, depending on a UE's own implementation, a “UE panel” may have at least one of the following functionalities as an operational role of unit of antenna group to control its transmit (“TX”) beam independently, unit of antenna group to control its transmission power independently, and/pr unit of antenna group to control its transmission timing independently. The “UE panel” may be transparent to a gNB. For certain conditions, a gNB or network may assume that a mapping between a UE's physical antennas to the logical entity “UE panel” may not be changed. For example, a condition may include until the next update or report from UE or include a duration of time over which the gNB assumes there will be no change to mapping. A UE may report its UE capability with respect to the “UE panel” to the gNB or network. The UE capability may include at least the number of “UE panels.” In one embodiment, a UE may support UL transmission from one beam within a panel. With multiple panels, more than one beam (e.g., one beam per panel) may be used for UL transmission. In another embodiment, more than one beam per panel may be supported and/or used for UL transmission.

In some embodiments, an antenna port may be defined such that a channel over which a symbol on the antenna port is conveyed may be inferred from the channel over which another symbol on the same antenna port is conveyed.

In certain embodiments, two antenna ports are said to be quasi co-located (“QCL”) if large-scale properties of a channel over which a symbol on one antenna port is conveyed may be inferred from the channel over which a symbol on another antenna port is conveyed. Large-scale properties may include one or more of delay spread, Doppler spread, Doppler shift, average gain, average delay, and/or spatial receive (“RX”) parameters. Two antenna ports may be quasi co-located with respect to a subset of the large-scale properties and different subset of large-scale properties may be indicated by a QCL Type. For example, a qcl-Type may take one of the following values: 1) ‘QCL-TypeA’: {Doppler shift, Doppler spread, average delay, delay spread}; 2) ‘QCL-TypeB’: {Doppler shift, Doppler spread}: 3) ‘QCL-TypeC’: {Doppler shift, average delay}; and 4) ‘QCL-TypeD’: {Spatial Rx parameter}. Other QCL-Types may be defined based on combination of one or large-scale properties.

In various embodiments, spatial RX parameters may include one or more of: angle of arrival (“AoA”), dominant AoA, average AoA, angular spread, power angular spectrum (“PAS”) of AoA, average angle of departure (“AoD”), PAS of AoD, transmit and/or receive channel correlation, transmit and/or receive beamforming, and/or spatial channel correlation.

In certain embodiments, QCL-TypeA, QCL-TypeB, and QCL-TypeC may be applicable for all carrier frequencies, but QCL-TypeD may be applicable only in higher carrier frequencies (e.g., mm Wave, FR2, and beyond), where the UE may not be able to perform omni-directional transmission (e.g., the UE would need to form beams for directional transmission). For a QCL-TypeD between two reference signals A and B, the reference signal A is considered to be spatially co-located with reference signal B and the UE may assume that the reference signals A and B can be received with the same spatial filter (e.g., with the same RX beamforming weights).

In some embodiments, an “antenna port” may be a logical port that may correspond to a beam (e.g., resulting from beamforming) or may correspond to a physical antenna on a device. In certain embodiments, a physical antenna may map directly to a single antenna port in which an antenna port corresponds to an actual physical antenna. In various embodiments, a set of physical antennas, a subset of physical antennas, an antenna set, an antenna array, or an antenna sub-array may be mapped to one or more antenna ports after applying complex weights and/or a cyclic delay to the signal on each physical antenna. The physical antenna set may have antennas from a single module or panel or from multiple modules or panels. The weights may be fixed as in an antenna virtualization scheme, such as cyclic delay diversity (“CDD”). A procedure used to derive antenna ports from physical antennas may be specific to a device implementation and transparent to other devices.

In certain embodiments, a transmission configuration indicator (“TCI”) state (“TCI-state”) associated with a target transmission may indicate parameters for configuring a quasi-co-location relationship between the target transmission (e.g., target RS of demodulation (“DM”) reference signal (“RS”) (“DM-RS”) ports of the target transmission during a transmission occasion) and a source reference signal (e.g., synchronization signal block (“SSB”), CSI-RS, and/or sounding reference signal (“SRS”)) with respect to quasi co-location type parameters indicated in a corresponding TCI state. The TCI describes which reference signals are used as a QCL source, and what QCL properties may be derived from each reference signal. A device may receive a configuration of a plurality of transmission configuration indicator states for a serving cell for transmissions on the serving cell. In some embodiments, a TCI state includes at least one source RS to provide a reference (e.g., UE assumption) for determining QCL and/or a spatial filter.

In some embodiments, spatial relation information associated with a target transmission may indicate a spatial setting between a target transmission and a reference RS (e.g., SSB, CSI-RS, and/or SRS). For example, a UE may transmit a target transmission with the same spatial domain filter used for receiving a reference RS (e.g., DL RS such as SSB and/or CSI-RS). In another example, a UE may transmit a target transmission with the same spatial domain transmission filter used for the transmission of a RS (e.g., UL RS such as SRS). A UE may receive a configuration of multiple spatial relation information configurations for a serving cell for transmissions on a serving cell.

In various embodiments described herein, although entities are referred to as IAB nodes, the same embodiments can be applied to IAB donors (e.g., which are the IAB entities connecting the core network to the IAB network) with minimum or zero modifications. Moreover, different steps described for different embodiments may be permuted. Further, each configuration may be provided by one or more configurations in practice. An earlier configuration may provide a subset of parameters while a later configuration may provide another subset of parameters. In certain embodiments, a later configuration may override values provided by an earlier configuration or a pre-configuration.

In some embodiments, a configuration may be provided by radio resource control (“RRC”) signaling, medium-access control (“MAC”) signaling, physical layer signaling such as a downlink control information (“DCI”) message, a combination thereof, or other methods. A configuration may include a pre-configuration or a semi-static configuration provided by a standard, by a vendor, and/or by a network and/or operator. Each parameter value received through configuration or indication may override previous values for a similar parameter.

In various embodiments, despite frequent references to IAB, embodiments herein may be applicable to wireless relay nodes and other types of wireless communication entities. Further, layer 1 (“L1”) and/or layer 2 (“L2”) control signaling may refer to control signaling in layer 1 (e.g., physical layer) or layer 2 (e.g., data link layer). Particularly, an L1 and/or L2 control signaling may refer to an L1 control signaling such as a DCI message or an uplink control information (“UCI”) message, an L2 control signaling such as a MAC message, or a combination thereof. A format and an interpretation of an L1 and/or L2 control signaling may be determined by a standard, a configuration, other control signaling, or a combination thereof.

It should be noted that any parameter discussed in this disclosure may appear, in practice, as a linear function of that parameter in signaling or specifications.

In certain embodiments, in any timing assignment for a slot that contains a signal, a timing assignment by a sign such as ‘=’ or ‘:=’ or a like may mean that the start time of the slot containing the signal is equal to a determined value such as a right hand side of the equation. In some embodiments, a start time of the slot containing the signal may be different from the determined value by an integer multiple of Tₛₗₒₜ, where Tₛₗₒₜ denotes a slot duration for a given numerology or subcarrier spacing (“SCS”). This may be applicable to all timing assignments found herein. In various embodiments, the values may be different by an integer multiple of T_{symbol} rather than an integer multiple of Tₛₗₒₜ, where T_{symbol} denotes a symbol duration for a given numerology or SCS.

In various embodiments, vendor manufacturing IAB systems and/or devices and an operator deploying the IAB systems and/or devices may be allowed to negotiate capabilities of the systems and/or devices. This may mean that some of the information assumed to need signaling between entities may readily be available to the devices, for example, by storing the information on a memory unit such as a read-only memory (“ROM”), exchanging the information by proprietary signaling methods, providing the information by a (pre) configuration, or otherwise taking the information into account when creating hardware and/or software of the IAB systems and/or devices or other entities in the network. In certain embodiments, embodiments described herein that include exchanging information may be extended to similar embodiments wherein the information is obtained by other embodiments.

Further, embodiments used for an IAB mobile terminal (“MT”) (“IAB-MT”) may be adopted by a UE as well. If an embodiment uses a capability that is not supported by a legacy UE, a UE enhanced to possess the capability may be used. In this case, the UE may be referred to as an enhanced UE or an IAB-enhanced UE and may convey its information of its enhanced capability to the network for proper configuration and operation.

As used herein, a node or a wireless node may refer to an IAB node, an IAB-DU, an IAB-MT, a UE, a base station (“BS”), a gNodeB (“gNB”), a transmit-receive point (“TRP”), an IAB donor, and so forth. The embodiments herein with an emphasis on a type of nodes are not meant to limit scope.

As used herein, “HARQ-ACK” may represent collectively the positive acknowledge (“ACK”) and the negative acknowledge (“NACK”). ACK means that a transport block (“TB”) is correctly received while NACK (or NAK) means a TB is erroneously received.

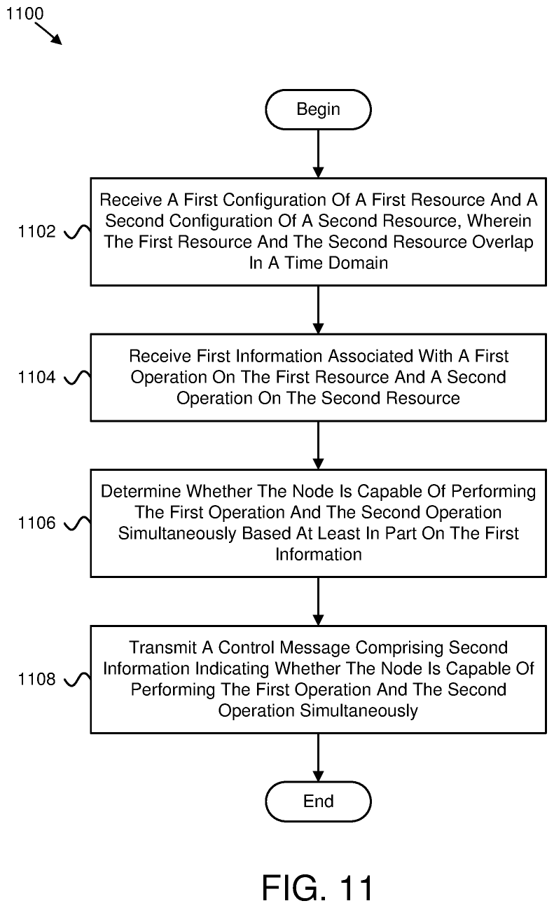

FIG. 11 is a flow chart diagram illustrating one embodiment of a method 1100 for performing simultaneous wireless communication operations. In some embodiments, the method 1100 is performed by an apparatus, such as the network unit 104. In certain embodiments, the method 1100 may be performed by a processor executing program code, for example, a microcontroller, a microprocessor, a CPU, a GPU, an auxiliary processing unit, a FPGA, or the like.

In various embodiments, the method 1100 includes receiving 1102, at a node, a first configuration of a first resource and a second configuration of a second resource. The first resource and the second resource overlap in a time domain. In some embodiments, the method 1100 includes receiving 1104 first information associated with a first operation on the first resource and a second operation on the second resource. In certain embodiments, the method 1100 includes determining 1106 whether the node is capable of performing the first operation and the second operation simultaneously based at least in part on the first information. In various embodiments, the method 1100 includes transmitting 1108 a control message including second information indicating whether the node is capable of performing the first operation and the second operation simultaneously.

In certain embodiments: the node comprises an integrated access and backhaul (IAB) node: the first resource is associated with an integrated access and backhaul mobile terminal (IAB-MT) of the IAB node; and the second resource is associated with an integrated access and backhaul node distributed unit (IAB-DU) of the IAB node. In some embodiments, the first information comprises: a first spatial parameter associated with the IAB-MT and a second spatial parameter associated with the IAB-DU; a first transmission power or first reception power associated with the IAB-MT and a second transmission power or a second reception power associated with the IAB-DU; a first interference associated with the IAB-MT and a second interference associated with the IAB-DU; a first timing alignment associated with the IAB-MT and a second timing alignment associated with the IAB-DU; a third timing alignment associated with the IAB-MT and the IAB-DU; or some combination thereof.

In various embodiments: the first operation is a first transmission, a first reception, or a combination thereof; and the second operation is a second transmission, a second reception, or a combination thereof. In one embodiment, the first information comprises: a first spatial parameter associated with the first operation and a second spatial parameter associated with the second operation: a first power associated with the first operation and a second power associated with the second operation: a first interference associated with the first operation and a second interference associated with the second operation: a first timing alignment associated with the first operation and a second timing alignment associated with the second operation: a third timing alignment associated with the first operation and the second operation: or some combination thereof.

In certain embodiments, the control message further comprises: a first parameter identifying the first resource: a second parameter identifying the second resource: a third parameter identifying the first operation: a fourth parameter identifying the second operation: a fifth at least one parameter associated with the first information: or some combination thereof. In some embodiments, the control message is transmitted to a serving node of the node. In various embodiments, determining whether the node is capable of performing the first operation and the second operation simultaneously is further based on a capability of the node, and the capability is associated with a number of antenna panels of the node, a processing capability of the node, a total power threshold, a power imbalance threshold, an interference threshold, a timing alignment capability, or some combination thereof.

In one embodiment: the first configuration associates a first resource attribute to the first resource, wherein the first resource attribute comprises downlink, uplink, flexible, hard, soft, unavailable, or some combination thereof; and the second configuration associates a second resource attribute to the second resource, wherein the second resource attribute comprises downlink, uplink, flexible, hard, soft, unavailable, or some combination thereof. In certain embodiments: the first configuration indicates that the first resource is a flexible resource; and determining whether the node is capable of performing the first operation and the second operation simultaneously is further based on whether a second control message indicates that the first resource takes a downlink direction.

In some embodiments: the first configuration indicates that the first resource is a flexible resource; and determining whether the node is capable of performing the first operation and the second operation simultaneously is further based on whether a second control message indicates that the first resource takes an uplink direction. In various embodiments: the second configuration indicates that the second resource is a soft resource; and determining whether the node is capable of performing the first operation and the second operation simultaneously is further based on whether a second control message indicates that the second resource is available.

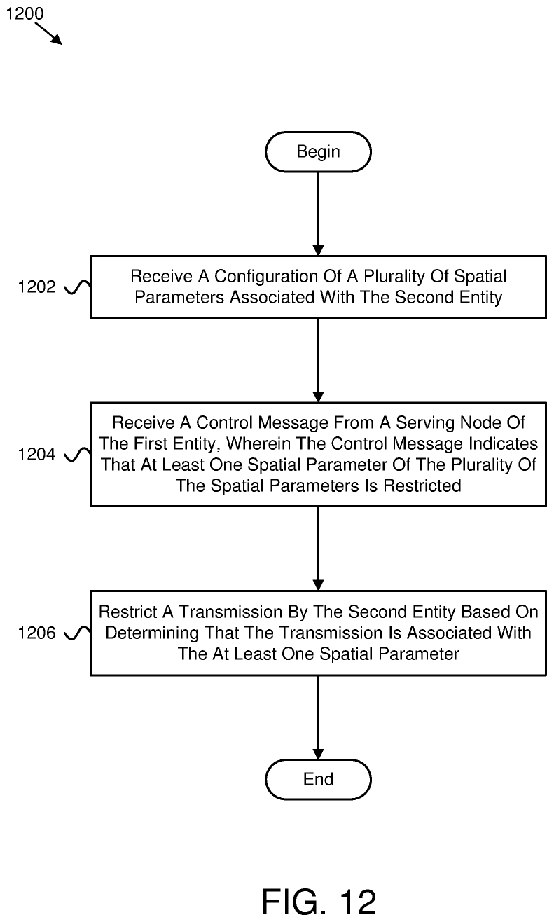

FIG. 12 is a flow chart diagram illustrating another embodiment of a method 1200 for performing simultaneous wireless communication operations. In some embodiments, the method 1200 is performed by an apparatus, such as the network unit 104. In certain embodiments, the method 1200 may be performed by a processor executing program code, for example, a microcontroller, a microprocessor, a CPU, a GPU, an auxiliary processing unit, a FPGA, or the like.

In various embodiments, the method 1200 includes receiving 1202, at a node, a configuration of a plurality of spatial parameters associated with the second entity. In some embodiments, the method 1200 includes receiving 1204 a control message from a serving node of the first entity. The control message indicates that at least one spatial parameter of the plurality of the spatial parameters is restricted. In certain embodiments, the method 1200 includes restricting 1206 a transmission by the second entity based on determining that the transmission is associated with the at least one spatial parameter.

In certain embodiments: the node comprises an integrated access and backhaul (IAB) node: the first entity comprises an integrated access and backhaul mobile terminal (IAB-MT); and the second entity comprises an integrated access and backhaul distributed unit (IAB-DU). In some embodiments, the spatial parameter comprises a reference signal identifier, a reference signal resource identifier, a transmission configuration indication, or some combination thereof.

In various embodiments, restricting the transmission comprises cancelling the transmission, changing a schedule of the transmission, changing a spatial parameter associated with the transmission, or some combination thereof. In one embodiment, the control message further indicates an association with at least one resource in a time domain, a time duration, at least one resource in a frequency domain, a frequency range, a timing alignment mode, or some combination thereof.

In one embodiment, a method of wireless communication at a node comprises: receiving a first configuration of a first resource and a second configuration of a second resource, wherein the first resource and the second resource overlap in a time domain: receiving first information associated with a first operation on the first resource and a second operation on the second resource: determining whether the node is capable of performing the first operation and the second operation simultaneously based at least in part on the first information; and transmitting a control message comprising second information indicating whether the node is capable of performing the first operation and the second operation simultaneously.

In certain embodiments: the node comprises an integrated access and backhaul (IAB) node: the first resource is associated with an integrated access and backhaul mobile terminal (IAB-MT) of the IAB node; and the second resource is associated with an integrated access and backhaul node distributed unit (IAB-DU) of the IAB node.

In some embodiments, the first information comprises: a first spatial parameter associated with the IAB-MT and a second spatial parameter associated with the IAB-DU: a first transmission power or first reception power associated with the IAB-MT and a second transmission power or a second reception power associated with the IAB-DU: a first interference associated with the IAB-MT and a second interference associated with the IAB-DU: a first timing alignment associated with the IAB-MT and a second timing alignment associated with the IAB-DU; a third timing alignment associated with the LAB-MT and the IAB-DU: or some combination thereof.

In various embodiments: the first operation is a first transmission, a first reception, or a combination thereof; and the second operation is a second transmission, a second reception, or a combination thereof.

In one embodiment, the first information comprises: a first spatial parameter associated with the first operation and a second spatial parameter associated with the second operation: a first power associated with the first operation and a second power associated with the second operation: a first interference associated with the first operation and a second interference associated with the second operation: a first timing alignment associated with the first operation and a second timing alignment associated with the second operation: a third timing alignment associated with the first operation and the second operation: or some combination thereof.

In certain embodiments, the control message further comprises: a first parameter identifying the first resource: a second parameter identifying the second resource: a third parameter identifying the first operation: a fourth parameter identifying the second operation: a fifth at least one parameter associated with the first information: or some combination thereof.

In some embodiments, the control message is transmitted to a serving node of the node.

In various embodiments, determining whether the node is capable of performing the first operation and the second operation simultaneously is further based on a capability of the node, and the capability is associated with a number of antenna panels of the node, a processing capability of the node, a total power threshold, a power imbalance threshold, an interference threshold, a timing alignment capability, or some combination thereof.

In one embodiment: the first configuration associates a first resource attribute to the first resource, wherein the first resource attribute comprises downlink, uplink, flexible, hard, soft, unavailable, or some combination thereof; and the second configuration associates a second resource attribute to the second resource, wherein the second resource attribute comprises downlink, uplink, flexible, hard, soft, unavailable, or some combination thereof.

In certain embodiments: the first configuration indicates that the first resource is a flexible resource; and determining whether the node is capable of performing the first operation and the second operation simultaneously is further based on whether a second control message indicates that the first resource takes a downlink direction.

In some embodiments: the first configuration indicates that the first resource is a flexible resource; and determining whether the node is capable of performing the first operation and the second operation simultaneously is further based on whether a second control message indicates that the first resource takes an uplink direction.

In various embodiments: the second configuration indicates that the second resource is a soft resource; and determining whether the node is capable of performing the first operation and the second operation simultaneously is further based on whether a second control message indicates that the second resource is available.

In one embodiment, an apparatus of wireless communication comprises a node. The apparatus further comprises: a receiver that: receives a first configuration of a first resource and a second configuration of a second resource, wherein the first resource and the second resource overlap in a time domain; and receives first information associated with a first operation on the first resource and a second operation on the second resource: a processor that determines whether the node is capable of performing the first operation and the second operation simultaneously based at least in part on the first information; and a transmitter that transmits a control message comprising second information indicating whether the node is capable of performing the first operation and the second operation simultaneously.

In certain embodiments: the node comprises an integrated access and backhaul (IAB) node: the first resource is associated with an integrated access and backhaul mobile terminal (IAB-MT) of the IAB node; and the second resource is associated with an integrated access and backhaul node distributed unit (IAB-DU) of the IAB node.

In some embodiments, the first information comprises: a first spatial parameter associated with the IAB-MT and a second spatial parameter associated with the IAB-DU: a first transmission power or first reception power associated with the IAB-MT and a second transmission power or a second reception power associated with the IAB-DU: a first interference associated with the IAB-MT and a second interference associated with the IAB-DU: a first timing alignment associated with the IAB-MT and a second timing alignment associated with the IAB-DU; a third timing alignment associated with the IAB-MT and the IAB-DU: or some combination thereof.

In various embodiments: the first operation is a first transmission, a first reception, or a combination thereof; and the second operation is a second transmission, a second reception, or a combination thereof.

In one embodiment, the first information comprises: a first spatial parameter associated with the first operation and a second spatial parameter associated with the second operation: a first power associated with the first operation and a second power associated with the second operation: a first interference associated with the first operation and a second interference associated with the second operation: a first timing alignment associated with the first operation and a second timing alignment associated with the second operation: a third timing alignment associated with the first operation and the second operation: or some combination thereof.

In certain embodiments, the control message further comprises: a first parameter identifying the first resource: a second parameter identifying the second resource: a third parameter identifying the first operation: a fourth parameter identifying the second operation: a fifth at least one parameter associated with the first information: or some combination thereof.

In some embodiments, the control message is transmitted to a serving node of the node.

In various embodiments, the processor determining whether the node is capable of performing the first operation and the second operation simultaneously is further based on a capability of the node, and the capability is associated with a number of antenna panels of the node, a processing capability of the node, a total power threshold, a power imbalance threshold, an interference threshold, a timing alignment capability, or some combination thereof.

In one embodiment: the first configuration associates a first resource attribute to the first resource, wherein the first resource attribute comprises downlink, uplink, flexible, hard, soft, unavailable, or some combination thereof; and the second configuration associates a second resource attribute to the second resource, wherein the second resource attribute comprises downlink, uplink, flexible, hard, soft, unavailable, or some combination thereof.

In certain embodiments: the first configuration indicates that the first resource is a flexible resource; and the processor determining whether the node is capable of performing the first operation and the second operation simultaneously is further based on whether a second control message indicates that the first resource takes a downlink direction.

In some embodiments: the first configuration indicates that the first resource is a flexible resource; and the processor determining whether the node is capable of performing the first operation and the second operation simultaneously is further based on whether a second control message indicates that the first resource takes an uplink direction.

In various embodiments: the second configuration indicates that the second resource is a soft resource; and the processor determining whether the node is capable of performing the first operation and the second operation simultaneously is further based on whether a second control message indicates that the second resource is available.

In one embodiment, a method of wireless communication at a node comprises a first entity and a second entity. The method comprises: receiving a configuration of a plurality of spatial parameters associated with the second entity: receiving a control message from a serving node of the first entity, wherein the control message indicates that at least one spatial parameter of the plurality of the spatial parameters is restricted; and restricting a transmission by the second entity based on determining that the transmission is associated with the at least one spatial parameter.

In certain embodiments: the node comprises an integrated access and backhaul (IAB) node: the first entity comprises an integrated access and backhaul mobile terminal (IAB-MT); and the second entity comprises an integrated access and backhaul distributed unit (IAB-DU).

In some embodiments, the spatial parameter comprises a reference signal identifier, a reference signal resource identifier, a transmission configuration indication, or some combination thereof.

In various embodiments, restricting the transmission comprises cancelling the transmission, changing a schedule of the transmission, changing a spatial parameter associated with the transmission, or some combination thereof.

In one embodiment, the control message further indicates an association with at least one resource in a time domain, a time duration, at least one resource in a frequency domain, a frequency range, a timing alignment mode, or some combination thereof.

In one embodiment, an apparatus of wireless communication comprises a node and further comprises a first entity and a second entity. The apparatus further comprises: a receiver that: receives a configuration of a plurality of spatial parameters associated with the second entity; and receives a control message from a serving node of the first entity, wherein the control message indicates that at least one spatial parameter of the plurality of the spatial parameters is restricted; and a processor that restricts a transmission by the second entity based on determining that the transmission is associated with the at least one spatial parameter.

In certain embodiments: the node comprises an integrated access and backhaul (IAB) node: the first entity comprises an integrated access and backhaul mobile terminal (IAB-MT); and the second entity comprises an integrated access and backhaul distributed unit (IAB-DU).

In some embodiments, the spatial parameter comprises a reference signal identifier, a reference signal resource identifier, a transmission configuration indication, or some combination thereof.

In various embodiments, the processor restricting the transmission comprises the processor cancelling the transmission, changing a schedule of the transmission, changing a spatial parameter associated with the transmission, or some combination thereof.

In one embodiment, the control message further indicates an association with at least one resource in a time domain, a time duration, at least one resource in a frequency domain, a frequency range, a timing alignment mode, or some combination thereof.

Embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

1. A method of performing a network function, the method comprising:
receiving a first configuration of a first resource and a second configuration of a second resource, wherein the first resource and the second resource overlap in a time domain;
receiving first information associated with a first operation on the first resource and a second operation on the second resource;
determining whether a node is capable of performing the first operation and the second operation simultaneously based at least in part on the first information; and
transmitting a control message comprising second information indicating whether the node is capable of performing the first operation and the second operation simultaneously.

2. An apparatus for performing a network function, the apparatus comprising:
at least one memory; and
at least one processor coupled with the at least one memory and configured to cause the apparatus to:
receive a first configuration of a first resource and a second configuration of a second resource, wherein the first resource and the second resource overlap in a time domain;
receive first information associated with a first operation on the first resource and a second operation on the second resource;
determine whether a node is capable of performing the first operation and the second operation simultaneously based at least in part on the first information; and
transmit a control message comprising second information indicating whether the node is capable of performing the first operation and the second operation simultaneously.

3. The apparatus of claim 2, wherein:
the node comprises an integrated access and backhaul (IAB) node;
the first resource is associated with an integrated access and backhaul mobile terminal (IAB-MT) of the IAB node; and
the second resource is associated with an integrated access and backhaul node distributed unit (IAB-DU) of the IAB node.

4. The apparatus of claim 3, wherein the first information comprises:
a first spatial parameter associated with the IAB-MT and a second spatial parameter associated with the IAB-DU;
a first transmission power or first reception power associated with the IAB-MT and a second transmission power or a second reception power associated with the IAB-DU;
a first interference associated with the IAB-MT and a second interference associated with the IAB-DU;
a first timing alignment associated with the IAB-MT and a second timing alignment associated with the IAB-DU;
a third timing alignment associated with the IAB-MT and the IAB-DU;
or a combination thereof.

5. The apparatus of claim 2, wherein:
the first operation is a first transmission, a first reception, or a combination thereof; and
the second operation is a second transmission, a second reception, or a combination thereof.

6. The apparatus of claim 2, wherein the first information comprises:
a first spatial parameter associated with the first operation and a second spatial parameter associated with the second operation;
a first power associated with the first operation and a second power associated with the second operation;
a first interference associated with the first operation and a second interference associated with the second operation;
a first timing alignment associated with the first operation and a second timing alignment associated with the second operation;
a third timing alignment associated with the first operation and the second operation;
or a combination thereof.

7. The apparatus of claim 2, wherein the control message further comprises:
a first parameter identifying the first resource;
a second parameter identifying the second resource;
a third parameter identifying the first operation;
a fourth parameter identifying the second operation;
a fifth at least one parameter associated with the first information;
or a combination thereof.

8. The apparatus of claim 2, wherein the control message is transmitted to a serving node of the node.

9. The apparatus of claim 2, wherein the processor determining whether the node is capable of performing the first operation and the second operation simultaneously is further based on a capability of the node, and the capability is associated with a number of antenna panels of the node, a processing capability of the node, a total power threshold, a power imbalance threshold, an interference threshold, a timing alignment capability, or some a combination thereof.

10. The apparatus of claim 2, wherein:
the first configuration associates a first resource attribute to the first resource, wherein the first resource attribute comprises downlink, uplink, flexible, hard, soft, unavailable, or a combination thereof; and
the second configuration associates a second resource attribute to the second resource, wherein the second resource attribute comprises downlink, uplink, flexible, hard, soft, unavailable, or a combination thereof.

11. The apparatus of claim 2, wherein:
the first configuration indicates that the first resource is a flexible resource; and
the processor determining whether the node is capable of performing the first operation and the second operation simultaneously is further based on whether a second control message indicates that the first resource takes a downlink direction.

12. The apparatus of claim 2, wherein:
the first configuration indicates that the first resource is a flexible resource; and
the processor determining whether the node is capable of performing the first operation and the second operation simultaneously is further based on whether a second control message indicates that the first resource takes an uplink direction.

13. The apparatus of claim 2, wherein:
the second configuration indicates that the second resource is a soft resource; and
the processor determining whether the node is capable of performing the first operation and the second operation simultaneously is further based on whether a second control message indicates that the second resource is available.

14. An apparatus for performing a network function, the apparatus comprising:
at least one memory; and
at least one processor coupled with the at least one memory and configured to cause the apparatus to:
receive a configuration of a plurality of spatial parameters associated with a second entity;
receive a control message from a serving node of a first entity, wherein the control message indicates that at least one spatial parameter of the plurality of the spatial parameters is restricted; and
restrict a transmission by the second entity based on determining that the transmission is associated with the at least one spatial parameter.

15. The apparatus of claim 14, wherein:
the node comprises an integrated access and backhaul (IAB) node;
the first entity comprises an integrated access and backhaul mobile terminal (IAB-MT); and
the second entity comprises an integrated access and backhaul distributed unit (IAB-DU).

16. The method of claim 1, wherein:
the node comprises an integrated access and backhaul (IAB) node;
the first resource is associated with an integrated access and backhaul mobile terminal (IAB-MT) of the IAB node; and
the second resource is associated with an integrated access and backhaul node distributed unit (IAB-DU) of the IAB node.

17. The method of claim 16, wherein the first information comprises:
a first spatial parameter associated with the IAB-MT and a second spatial parameter associated with the IAB-DU;
a first transmission power or first reception power associated with the IAB-MT and a second transmission power or a second reception power associated with the IAB-DU;
a first interference associated with the IAB-MT and a second interference associated with the IAB-DU;
a first timing alignment associated with the IAB-MT and a second timing alignment associated with the IAB-DU;
a third timing alignment associated with the IAB-MT and the IAB-DU;
or a combination thereof.

18. The method of claim 1, wherein:
the first operation is a first transmission, a first reception, or a combination thereof; and
the second operation is a second transmission, a second reception, or a combination thereof.

19. A method of performing a network function, the method comprising:
receiving a configuration of a plurality of spatial parameters associated with a second entity;
receiving a control message from a serving node of a first entity, wherein the control message indicates that at least one spatial parameter of the plurality of the spatial parameters is restricted; and
restricting a transmission by the second entity based on determining that the transmission is associated with the at least one spatial parameter.

20. The method of claim 19, wherein:
the node comprises an integrated access and backhaul (IAB) node;
the first entity comprises an integrated access and backhaul mobile terminal (IAB-MT); and
the second entity comprises an integrated access and backhaul distributed unit (IAB-DU).
